(19) United States
(12) Patent Application Publication
(10) Pub. No.: US 2026/0336736 A1
(43) Pub. Date: Oct. 29, 2026

(54) HEIGHT ADJUSTABLE SEAT POSTS FOR BICYCLES

(71) Applicant: SRAM, LLC, CHICAGO, IL (US)

(72) Inventors: BRIAN JORDAN, CHICAGO, IL (US); SAGE HAHN, CHICAGO, IL (US); CHARLES DUNLAP, MANITOU SPRINGS, CO (US)

(73) Assignee: SRAM, LLC, CHICAGO, IL (US)

(21) Appl. No.: 19/187,697

(22) Filed: Apr. 23, 2025

(51) Int. Cl. B62J 1/08

(52) U.S. Cl. CPC B62J 1/08; B62J 2001/085

(57) ABSTRACT

Height adjustable seat posts for bicycles are described herein. A height adjustable seat post includes a first tube and a second tube configured in a telescopic arrangement. The height adjustable seat post includes a first chamber, a second chamber, and a valve disposed fluidly between the first chamber and the second chamber. The valve includes a flow control member that is moveable between a closed position and an open position. The seat post includes a valve actuator to move the flow control member. The seat post also includes a controller to: receive a control signal; in response to receiving the control signal, control the valve actuator to move the flow control member from the closed position to the open position; and automatically, after a predetermined time period from receiving the control signal, control the valve actuator to move the flow control member from the open position to the closed position.

### FIELD OF THE DISCLOSURE

This disclosure relates generally to bicycle components and, more specifically, to height adjustable seat posts for bicycles.

### BACKGROUND

Bicycles have a seat or saddle to support a rider in a seated position. The seat is typically connected to the bicycle frame by a seat post. On most bicycles, the seat post can be manually adjusted to raise or lower the height of the seat to accommodate riders of different heights. The height may also be adjusted to accommodate different riding conditions. Typically, the seat post is mechanically clamped to a tube of the bicycle frame. When the clamp is released, the seat post is slidable up and down relative to the tube of the bicycle frame to adjust the height of the seat. On some bicycles, the seat post is height adjustable during riding of the bicycle by employing a hydraulic assist mechanism. For example, manually actuated hydraulic height adjustable or “dropper” seat posts may use a hydraulic pressure differential within the post and require manual operation to adjust the seat post height. Some products may use ANT+ wireless communication technology allowing the rider to wirelessly adjust the seat post.

### SUMMARY

An example height adjustable seat post for a bicycle includes a first tube and a second tube configured in a telescopic arrangement. One of the first tube or the second tube is to be coupled to a frame of the bicycle, and the other of the first tube or the second tube is to be coupled to a seat. The height adjustable seat post includes a first chamber, a second chamber, and a valve disposed fluidly between the first chamber and the second chamber. The valve includes a flow control member that is moveable between a closed position in which fluid is blocked from flowing across the valve between the first and second chambers and an open position to enable the flow of fluid across the valve between the first and second chambers. The height adjustable seat post includes a valve actuator to move the flow control member of the valve between the closed position and the open position. The height adjustable seat post also includes a controller to: receive a control signal; in response to receiving the control signal, control the valve actuator to move the flow control member from the closed position to the open position; and automatically, after a predetermined time period from receiving the control signal, control the valve actuator to move the flow control member from the open position to the closed position.

An example height adjustable seat post for a bicycle includes a first tube and a second tube configured in a telescopic arrangement. One of the first tube or the second tube is to be coupled to a frame of the bicycle, and the other of the first tube or the second tube is to be coupled to a seat. The height adjustable seat post includes a height control mechanism to selectively facilitate relative movement between the first tube and the second tube in an open state and to restrict relative movement between the first tube and the second tube in a closed state. The height adjustable seat post also includes a controller to determine whether an actuation command is a first type of actuation command or a second type of actuation command. When the actuation command is a first type of actuation command, the controller is to control the height control mechanism to the open state when a seat post actuator is activated, maintain the open state while the seat post actuator is activated, and control the height control mechanism to the closed state when the seat post actuator is deactivated. When the actuation command is the second type of actuation command, the controller is to control the height control mechanism to the open state and then automatically, after a predetermined time period, control the height control mechanism to the closed state.

An example height adjustable seat post for a bicycle includes a first tube and a second tube configured in a telescopic arrangement. One of the first tube or the second tube is to be coupled to a frame of the bicycle, and the other of the first tube or the second tube is to be coupled to a seat. The height adjustable seat post includes a height control mechanism to selectively facilitate relative movement between the first tube and the second tube in an open state and to restrict relative movement between the first tube and the second tube in a closed state. The height adjustable seat post also includes a controller to determine whether an actuation command is a first type of actuation command or a second type of actuation command. When the actuation command is a first type of actuation command, the controller is to facilitate momentary user control of the height control mechanism. When the actuation command is the second type of actuation command, the controller is to facilitate automatic achievement of a suspension mode with the height control mechanism.

### BRIEF DESCRIPTION OF THE DRAWINGS

FIG. 1 is a side view of an example bicycle that may employ any of the example height adjustable seat posts disclosed herein.

FIG. 2 is a side view of an example height adjustable seat post in an extended position.

FIG. 3 is a side view of the example height adjustable seat post of FIG. 2 in a partially retracted or contracted position.

FIG. 4 is an enlarged view of an example control module that can be implemented on the example height adjustable seat post of FIG. 2.

FIG. 5 is a cross-sectional view of the example height adjustable seat post of FIG. 2 in the fully extended position.

FIG. 6 is a cross-sectional view of the example height adjustable seat post of FIG. 3 in the partially retracted or contracted position.

FIG. 7 is an enlarged view of the callout of FIG. 5 showing a cross-sectional view of an example piston assembly with an example actuator valve implemented in the example height adjustable seat post.

FIG. 8 illustrates an embodiment of the example height adjustable seat post of FIG. 2 in which an example actuator valve is disposed in an alternative location.

FIG. 9 is a side view of another example piston assembly with an example rotary valve that can be implemented in the example height adjustable seat pot of FIG. 2. The example rotary valve is in a closed state.

FIG. 10 is a cross-sectional view of the example piston assembly taken along lines A-A of FIG. 9 showing the example rotary valve in the closed state.

FIG. 11 is a cross-sectional view of the example piston assembly taken along lines B-B of FIG. 9 showing example openings in an example fixed disc.

FIG. 12 is a cross-sectional view of the example piston assembly taken along lines C-C of FIG. 9 showing an example rotatable disc in a closed position.

FIG. 13 is a side view of the example piston assembly of FIG. 9 in which the example rotary valve is in an open state.

FIG. 14 is a cross-sectional view of the example piston assembly taken along lines D-D of FIG. 13 showing the example rotary valve in the open state.

FIG. 15 is a cross-sectional view of the example piston assembly taken along lines E-E of FIG. 13 showing the example openings in the example fixed disc.

FIG. 16 is a cross-sectional view of the example piston assembly taken along lines F-F of FIG. 13 showing the example rotatable disc in an open position.

FIG. 17 is a cross-sectional view of another example piston assembly and example valve that can be implemented in the example height adjustable seat post of FIG. 2. FIG. 17 shows the valve in a closed state.

FIG. 18 shows the example valve of FIG. 17 in an open state.

FIG. 19 is a block diagram of the example controller and other components of the example height adjustable seat post of FIG. 2.

FIGS. 20A and 20B are side views of the example height adjustable seat post of FIG. 2 showing an incremental change in height.

FIG. 21 is a flowchart representative of example machine readable instructions and/or example operations that may be executed, instantiated, and/or performed by example programmable circuitry to implement the controller of FIG. 19.

FIG. 22 is a flowchart representative of example machine readable instructions and/or example operations that may be executed, instantiated, and/or performed by example programmable circuitry to implement the controller of FIG. 19.

FIG. 23 is a flowchart representative of example machine readable instructions and/or example operations that may be executed, instantiated, and/or performed by example programmable circuitry to implement the controller of FIG. 19.

FIG. 24 is a block diagram of an example processing platform including programmable circuitry structured to execute, instantiate, and/or perform the example machine readable instructions and/or perform the example operations of FIGS. 21-23 to implement the controller of FIG. 19.

The figures are not to scale. Instead, the thickness of the layers or regions may be enlarged in the drawings. In general, the same reference numbers will be used throughout the drawing(s) and accompanying written description to refer to the same or like parts.

### DETAILED DESCRIPTION

Some modern bicycles include height adjustable seat posts, sometimes referred to as dropper seat posts. This type of seat post allows a rider to change the height of their seat while riding the bicycle. For example, the rider can actuate a seat post actuator (e.g., a button) on the handlebars and then push downward on the seat (e.g., with a sitting force/motion) to contract or compress the seat post, which thereby lowers the height of the seat. When the rider stops actuating the seat post actuator (e.g., release the button), the seat post is maintained in the retracted (lowered) position. Then, when the rider desires to raise the seat, the rider can actuate the seat post actuator again and the seat post extends or expands to move the seat back to the original height or to a desired height between the retracted position and the original height. This lowering ability can be advantageous when the rider is about to ride the bicycle down a steep decline. For instance, it is often desired to lower the seat when riding down a decline so that the rider can stand up and move their body freely without interference from the seat. This lowering ability can also be used to lower the seat before the rider encounters an incline, where the rider typically stands up and pedals. This adjustability can be used in many other scenarios as well.

An example height adjustable seat post disclosed herein includes an internal valve that controls the flow of fluid between a positive chamber and a negative chamber in the seat post. The valve is operable between a closed state to block the flow of fluid between the two chambers, which locks the seat post at a certain height, and an open state in which fluid is allowed to flow between the two chambers, which enables the seat post to expand or contract (retract). The valve can be a linear valve or a rotary valve, for example. The example height adjustable seat post also includes a valve actuator, such as an electric motor or a solenoid, to operate (e.g., switch, move) the valve between the open and closed states. The valve actuator is controlled or activated by a controller (e.g., a processor). The controller receives signals from a seat post actuation button on the handlebars and can activate the valve actuator to control the valve.

In known seats posts, the controller is configured to activate the valve actuator to open the valve and maintain the valve in the open position until the seat post actuation button is released. For example, if a user desires to adjust the height of the seat, the rider presses and holds the seat post actuation button. The controller receives a signal from the seat post actuation button and activates the valve actuator to open the valve and maintain the valve in the open state the entire time the button is pressed. While the valve is open, the seat post height is adjustable. As such, the rider can move the seat downward by applying downward force to contract (shorten) the seat post, or can allow the seat to move upward by removing force on the seat and letting the seat post expand (lengthen). When the seat is at the desired height, the rider releases the seat post actuation button, and the controller closes the valve, which locks the seat post in at its current height. Typically, this process occurs while a rider has stopped pedaling. For example, the rider will first stop pedaling (e.g., coast), press and hold the seat post actuation button, adjust the seat post to a new position, release the seat post actuation button, and then resume pedaling. However, it is often difficult for a rider to make a relatively small adjustment to the seat height. In particular, a rider may only desire to make a relatively small change (e.g., 1 inch) to the seat height. Often, the rider makes a larger movement of the seat post, and then has to reverse the movement slightly (which may occur multiple times), until the desired seat height is reached. This process can become a nuisance and takes time away from pedaling and controlling the bicycle.

Disclosed herein are example controller techniques used to make small, incremental adjustments to the height of the seat post. An example controller disclosed herein is configured to open the valve when the rider presses the seat post action button, and then quickly close the valve. The closing of the valve is independent of any further input by the rider. Instead, the controller is configured to automatically close the valve after a predetermined time period. The predetermined time period may be defined based on various events. For example, the predetermined time period may begin upon a determination of a valve position, for example determining that the valve has begun to open or has achieved an open position. In another example, the predetermined time period begins once the control signal is received. The predetermined time period may be a relatively short time, such as 500 milliseconds (ms). As a result, the seat post can only be contracted (shortened) or expanded (lengthened) a small amount. For example, while the rider is sitting on the seat and applying downward force, the rider can press the sat post actuation button. The controller opens and closes the valve relatively quickly. As a result, the seat post retracts (shortens) a small amount, such as about 1 inch, and then automatically locks itself in the new position. If the rider desires to shorten the seat post further, the rider can press the seat post actuation button again and the operation is repeated. The same process can be used to expand (lengthen) the seat post when no downward force is being applied to the seat. Therefore, each time the button is pressed, the seat post is adjusted (e.g., shortened or lengthened) by a small, incremental amount. Because this process happens relatively quickly, the rider can begin pedaling again a lot sooner.

Also disclosed herein are example controllers that are configured to operate in two different modes. In the first mode, the controller opens the valve and holds the valve open the entire time the seat post actuation button is pressed. This first mode enables a rider to make relatively large changes to the seat post height. In the second mode, the controller opens the valve and then quickly (and automatically) closes the valve. Therefore, the second mode can be used to enable a rider to easily make a small, increment adjustment to the seat post height. The rider can activate the first mode or the second mode based on different actuation commands from the seat post actuation button or from separate buttons or devices on the handlebars.

Also disclosed herein are example controllers that are configured to operate the seat post in a suspension mode. In the suspension mode, the seat post is moved to an intermediate position or length (also referred to as a suspension position) between the fully extended position and the full retracted position. For example, the controller may open the valve to enable the seat post to expand or retract until the intermediate position is reached, and then closes the valve to maintain the seat post in the intermediate position. While in the intermediate position, the seat post has a larger amount of sag, which is the small retraction of the seat post from the weight/force of the rider. This sag allows the seat post to slightly contract and/or expand, which helps absorb shocks and vibrations encountered by the bicycle. Therefore, the rider can activate the suspension mode when greater suspension is desired.

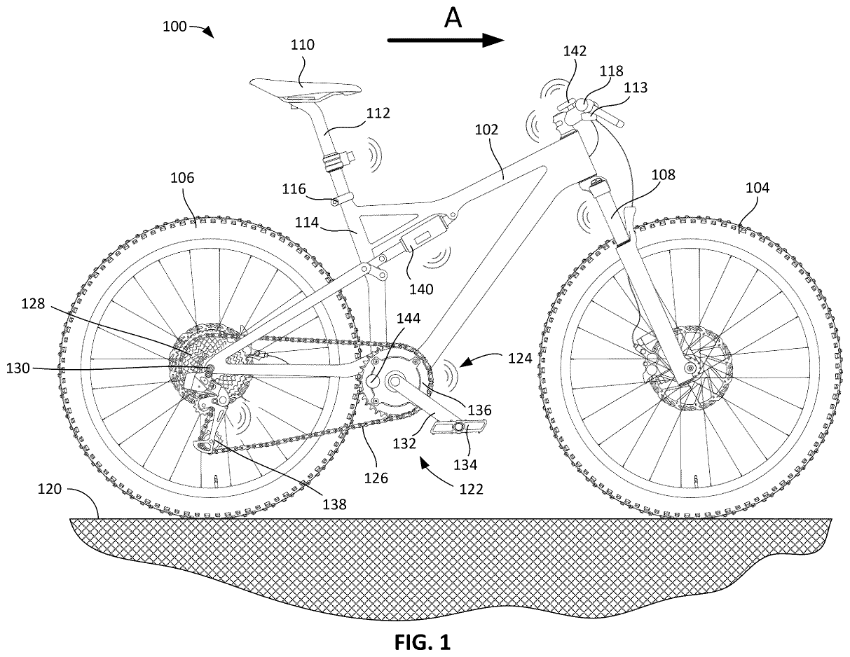

Turning now to the figures, FIG. 1 illustrates one example of a human powered vehicle on which the example seat posts disclosed herein can be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A.

In the illustrated example of FIG. 1, the bicycle 100 includes a seat 110 (sometimes referred to as a saddle). The seat 110 is coupled to the frame 102 (e.g., near the rear end of the frame 102 relative to the forward direction A) via a seat post 112, examples of which are disclosed in further detail herein. In the illustrated example, the seat post 112 is coupled to a seat tube 114 of the frame 102. In some examples, the seat post 112 is coupled to the seat tube 114 by a clamp 116. The seat post 112 is height adjustable to raise or lower the seat 110. The bicycle 100 includes a seat post actuator 113, such as a seat post actuation button, to control the seat post 112. The bicycle 100 also includes handlebars 118 coupled to the frame 102 and the front fork 108 (e.g., near a forward end of the frame 102 relative to the forward direction A) for steering the bicycle 100. In some examples, the seat post actuator 113 is mounted on the handlebars 118 to enable a rider to interact with the seat post actuator 113 while riding the bicycle 100. The bicycle 100 is shown on a riding surface 120. The riding surface 120 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 122 that includes a crank assembly 124. The crank assembly 124 is operatively coupled via a chain 126 to a sprocket assembly 128 mounted to a hub 130 of the rear wheel 106. The crank assembly 124 includes at least one, and typically two, crank arms 132 and pedals 134, along with at least one front sprocket, or chainring 136. A rear gear change device 138, such as a derailleur, is disposed at the rear wheel 106 to move the chain 126 between different sprockets of the sprocket assembly 128. Additionally or alternatively, the bicycle 100 may include a plurality of front chainrings and a front gear change device to move the chain 126 between the plurality of chainrings.

The example bicycle 100 can include a suspension system having one or more suspension components. In the illustrated example, the bicycle 100 includes a rear suspension component 140. In this example, the rear suspension component 140 is implemented as or includes a shock absorber. In some examples, the front fork 108 is also implemented as a front suspension component. For example, a spring can be integrated into one of the legs and a damper can be integrated into the other leg. The front fork 108 and the rear suspension component 140 absorb shocks and vibrations while riding the bicycle 100 (e.g., when riding over rough terrain). In other examples, the front fork 108 and/or the rear suspension component 140 may be integrated into the bicycle 100 in other configurations or arrangements. In some examples, the seat post 112 can operate in a suspension mode to help absorb shocks and vibrations, examples of which are disclosed in further detail herein.

In some examples, one or more of the components of the bicycle 100 may include electronic components for controlling and/or monitoring various aspects of the bicycle 100. For example, the bicycle 100 of FIG. 1 includes a control device or bicycle computer 142 that is mounted on the handlebars 118. The bicycle computer 142 may wirelessly communicate with the seat post 112, the rear gear change device 138, the front fork 108, and/or the rear suspension component 140 to collect data and/or control operation of the respective components. The bicycle computer 142 may also wirelessly communicate with a power meter 144 of the crank assembly 124. The foregoing components may be paired to a wireless network.

While the example bicycle 100 depicted in FIG. 1 is a type of mountain bicycle, the example height adjustable seat posts disclosed herein can be implemented on other types of bicycles. For example, the example seat posts disclosed herein may be used on road bicycles, as well as bicycles with mechanical (e.g., cable, hydraulic, pneumatic, etc.) and non-mechanical (e.g., wired, wireless) drive systems. The example seat posts disclosed herein may also be implemented on other types of two-wheeled, three-wheeled, and four-wheeled human powered vehicles. Further, the example seat posts disclosed herein can be used on other types of vehicles, such as motorized vehicles (e.g., a motorcycle).

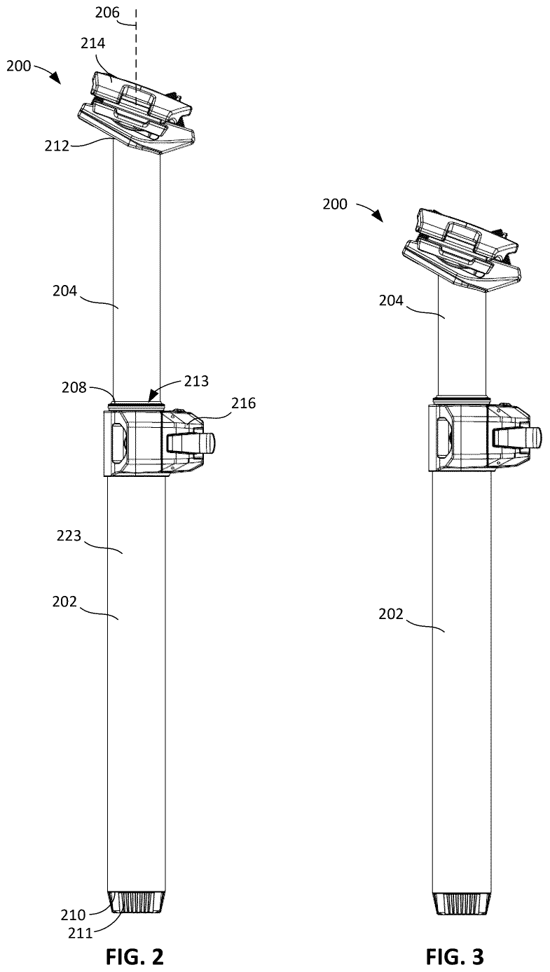

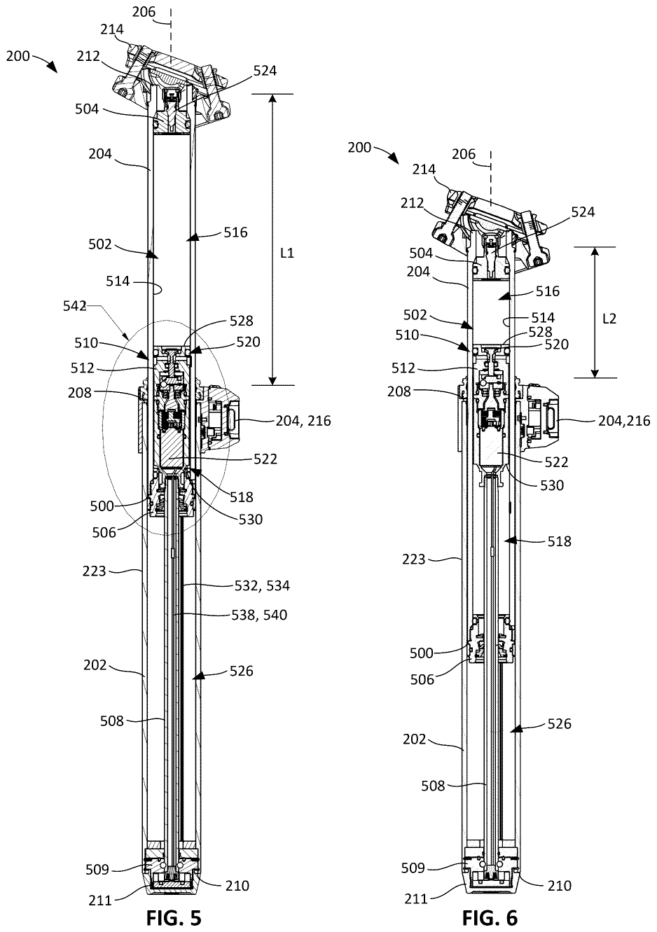

FIG. 2 is a side view of an example bicycle component in which the example valve actuation and current limit techniques disclosed herein can be implemented. In this example, the bicycle component is an example height adjustable seat post 200, which may also be referred to as a dropper seat post or seat post assembly. The example height adjustable seat post 200 that can be implemented as the seat post 112 on the bicycle 100 of FIG. 1. The length or height of the example seat post 200 is adjustable so that the height of the seat 110 (FIG. 1) can be raised or lowered. In the illustrated example, the seat post 112 includes a first tube 202, referred to herein as a lower tube 202, and a second tube 204, referred to herein as an upper tube 204. The lower and upper tubes 202, 204 may also be referred to as seat post portions or segments. As shown in FIG. 2, the lower and upper tubes 202, 204 are configured in a coaxial arrangement and aligned along an axis 206. The axis 206 corresponds to a central or longitudinal axis of the seat post 112. The lower tube 202 has a first end 208, referred to herein as an upper end 208, and a second end 210, referred to herein as a lower end 210, opposite the upper end 208. In this example, a lower cap assembly 211 is coupled to the lower end 210 of the lower tube 202. The upper tube 204 similarly has a first end 212, referred to herein as an upper end 212, and a second end 500 (shown in FIGS. 5 and 6), referred to herein as a lower end 500, opposite the upper end 212. The upper tube 204 and the lower tube 202 are configured in a telescopic arrangement. In particular, in this example, the upper tube 204 extends into an opening 213 in the upper end 208 of the lower tube 202. As such, the upper tube 204 is at least partially disposed in the lower tube 202. The upper tube 204 is slidable into and out of the opening 213 in the lower tube 202, which enables the overall height or length of the seat post 112 to change. In other examples, the lower and upper tubes 202, 204 can be configured such that the lower tube 202 extends into the lower end 500 of the upper tube 204.

In the illustrated example, the seat post 112 includes a seat clamp 214 that is coupled (e.g., welded, bolted, threaded, etc.) to the upper end 212 of the upper tube 204. The seat clamp 214 is used to couple the seat 110 (FIG. 1) to the seat post 112. In some examples, the seat clamp 214 includes two threaded fasteners that can be tightened to secure the seat 110 to the upper tube 204. In other examples, the seat post 112 can include other mechanisms for attaching to the seat 110.

When the seat post 112 is installed on the bicycle 100 (FIG. 1), the lower tube 202 is coupled to the frame 102 (FIG. 1). For example, the lower tube 202 can be inserted into the seat tube 114 (FIG. 1) and secured by the clamp 116 (FIG. 1). The upper tube 204 extends upward from the lower tube 202 and supports the seat 110 (FIG. 1). As disclosed in further detail herein, the seat post 112 has an internal valve that enables the upper tube 204 to move (e.g., slide) downward relative to the lower tube 202 and provides rebounding force to move the upper tube 204 upward relative to the lower tube 202. This enables a rider to easily lower the height of the seat 110 or raise the height of the seat 110. The seat post 112 is adjustable between a extended position (sometimes referred to as a top-out position), shown in FIG. 2, and a retracted position in which the upper tube 204 is moved into the lower tube 202 until a stop or limit is reached. The extended position represents a maximum length or height of the telescopic arrangement, and the retracted position represents a minimum length or height of the telescopic arrangement. The seat post 112 can also be expanded/retracted to any position between the extended position and the retracted position and maintained in place. For example, FIG. 3 shows an example in which the upper tube 204 has been partially moved into the lower tube 202. As such, the seat 110 (FIG. 1) would be lowered or closer to the ground compared to the position in FIG. 2. Therefore, the upper tube 204 and the lower tube 202 can be moved between at least a first position and a second position, where the first position may correspond to the extended position and the second position may correspond to the retracted position, or any position therebetween.

In the illustrated example of FIG. 2, the seat post 112 includes a control module 216. The control module 216 includes a power supply (e.g., a battery) and circuitry (e.g., a controller) to operate the internal valve. In this example, the control module 216 is coupled to an outer surface 223 of the lower tube 202 at or near the upper end 208 of the lower tube 202. However, in other examples, the control module 216 can be disposed in another location on the height adjustable seat post 200.

As an example operation, if a rider desires to lower the seat 110 (FIG. 1), the rider actuates the seat post actuator 113 (FIG. 1). The seat post actuator 113 can be mounted on the handlebars 118 such that the rider can actuate the seat post actuator 113 with one of his/her fingers (e.g., their thumb). In some examples, the seat post actuator 113 can be implemented as a button that can be pressed. Alternatively, the seat post actuator 113 can be a lever or other type of user interface such a display device with a touch screen. When the seat post actuator 113 is activated (e.g., pressed), the seat post actuator 113 transmits a control signal (e.g., a wireless signal) to the control module 216. The control module 216 receives the signal from the seat post actuator 113 and activates an electric actuator to open the internal valve, which is disposed in a pneumatic chamber in the upper tube 204, as disclosed in further detail herein. While the internal valve is open, the seat post 200 is adjustable. The rider can push downward on the seat 110 to cause the upper tube 204 to slide into the lower tube 202, as shown in the position of FIG. 3. In some examples, the rider can apply this force by sitting on the seat 110 and applying the downward force with their bottom. In some examples, the valve is held open until the rider releases the seat post actuator 113 (e.g., releases the button). Therefore, when the seat 110 reaches the desired height, the rider can release the seat post actuator 113 and the control module 216 closes the internal valve, which maintains the upper tube 204 in place relative to the lower tube 202. When the rider desires to raise the seat 110, the rider can press the seat post actuator 113 again. The control module 216 receives the signal and opens the internal valve. When little or no downward force is acting on the seat 110, the internal pneumatic system pushes the upper tube 204 upward from the lower tube 202, thereby moving the seat 110 upward. When the desired position is reached, the rider can release the seat post actuator 113, which causes the internal valve to close and holds the seat post 112 in the current position. In other examples disclosed herein, after the control module 216 opens the internal valve, the control module 216 automatically closes the interval valve after a predetermined time period, independent of the release of the seat post actuator 113. This results in a smaller, incremental change in height of the seat post 200. These operations enable the seat post height to be easily and quickly adjusted by the rider.

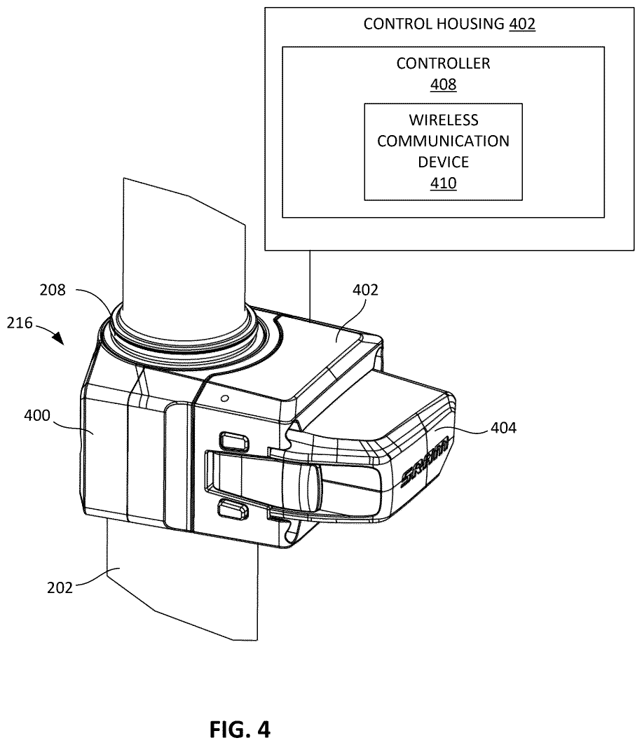

FIG. 4 is an enlarged view of the control module 216 on the lower tube 202. In the illustrated example, the control module 216 includes a collar 400, a control housing 402 coupled to the collar 400, and a power supply, in this example a battery 404, coupled to the control housing 402. The collar 400 is wrapped around the lower tube 202 and is used to couple the control module 216 to the lower tube 202. The control housing 402 contains electronic components for receiving control/commands signals and operating the internal valve (e.g., opening the valve, closing the valve, etc.). For example, FIG. 4 shows a block diagram of the control housing 402. The control housing 402 includes a controller 408. The controller 408 may include a wireless communication device 410. The wireless communication device 410 can receive wireless control/command signals from the seat post actuator 113 and/or another bicycle component such as the bicycle computer 142. Additionally, in some examples, the wireless communication device 410 can include a transmitter (e.g., a transceiver) and may send wireless control/command signals to the seat post actuator 113 and/or other bicycle components such as the bicycle computer 142. In response to receiving a command, for example, the controller 408 may activate the electric actuator to open the interval valve in the upper tube 204 to enable the seat post 112 to expand or contract. When the seat post actuator 113 is released, no control/command signals are received and the controller 408. As disclosed above, in some examples, the controller 408 activates the actuator to close the internal valve upon release of the seat post actuator 113. In other examples, the controller 408 can automatically close the internal valve after a predetermined time period, examples of which are disclosed in further detail herein. The wireless communication device 410 is configured to communicate wirelessly, and as such includes one or more antennas. The wireless communication device 410 provides for wireless communication in any known or later developed format. Although the present specification describes components and functions that may be implemented in particular embodiments with reference to particular standards and protocols, the examples disclosed herein are not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Bluetooth®, ANT+™, ZigBee, WiFi and/or AIREA™ standards may also, or alternatively, be used. Accordingly, replacement standards and protocols having the same or similar functions as those disclosed herein are considered equivalents thereof.

The battery 404 supplies electrical power to the controller 408, and the controller 408 regulates the supply of electrical power from the battery 404 to the electric actuator for operating the internal valve. The battery 404 may be rechargeable (e.g., via a physical cord or via wireless charging). In other examples, the battery 404 may be mounted remote from the seat post 200. For example, the battery 404 may be located on or internal to the frame 102 of the bicycle 100, for example in the case of a motorized bicycle or e-bike, and may be connected to the seat post 112 by electrical wires (e.g., one or more wires extending through or along the frame 102).

FIG. 5 is a cross-sectional view of the seat post 200 in the fully extended position corresponding to FIG. 2, and FIG. 6 is a cross-sectional view of the seat post 200 in a partially contracted or retracted position corresponding to FIG. 3. FIGS. 5 and 6 are described together. As shown in FIGS. 5 and 6, the upper tube 204 has a lower end 500. The lower end 500 is disposed in the lower tube 202. In FIG. 5, the amount of the upper tube 204 extending outward (e.g., upward) from the lower tube 202 is defined by a first length of L1, and in FIG. 6, the amount of the upper tube 204 extending outward from the lower tube 202 is defined by a second length L2, which is less than L1. As such, the overall height or length of the seat post 200 in FIG. 6 is less than the height or length of the seat post 200 in FIG. 5.

As shown in FIGS. 5 and 6, the upper tube 204 defines a sealed pressure chamber 502. The sealed pressure chamber 502 is filled with fluid (e.g., pneumatic gas), as discussed in further detail herein. The seat post 200 includes an upper sealhead 504 (e.g., a plug) coupled to the upper tube 204 at or near the upper end 212. The seat post 200 also includes a lower sealhead 506 coupled to the upper tube 204 at or near the lower end 500. The upper and lower sealheads 504, 506 seal the ends of the upper tube 204 to maintain the fluid in the sealed pressure chamber 502.

In the illustrated example of FIGS. 5 and 6, the seat post 200 includes a rod 508. The rod 508 is disposed in the lower tube 202 and coupled to the lower tube 202 (e.g., near the lower end 210), such that the rod 508 is fixed relative to the lower tube 202. For example, the lower cap assembly 211 includes a mount 509 disposed in and coupled to the lower tube 202 at the lower end 210. A bottom end of the rod 508 is coupled to the mount 509. The rod 508 extends upward through the lower tube 202 and through the lower sealhead 506 and into the upper tube 204. In particular, the rod 508 extends through the lower sealhead 506 and into the sealed pressure chamber 502 defined in the upper tube 204. The lower sealhead 506 is slidable up and down along the rod 508 as the seat post 200 expands or contracts.

In the illustrated example of FIGS. 5 and 6, the seat post 200 includes a piston assembly 510 disposed in the upper tube 204. The piston assembly 510 may also be referred to as a valve assembly or flow control assembly. The piston assembly 510 is disposed in the sealed pressure chamber 502 of the upper tube 204 and is coupled to the rod 508. As the seat post 200 expands or contracts, the piston assembly 510 moves closer to or further away from the upper and lower ends 212, 500 of the upper tube 204. The piston assembly 510 includes a piston 512 that is sealed against an inner surface 514 of the upper tube 204. The inner surface 514 of the upper tube 204 is slidable up and down along the piston 512 as the seat post 200 expands or contracts. The piston assembly 510 and, in particular, the piston 512, divides the sealed pressure chamber 502 of the upper tube 204 into a first chamber 516 (between the piston 512 and the upper sealhead 504) and a second chamber 518 (between the piston 512 and the lower sealhead 506). The first and second chambers 516, 518 may also be referred to as upper and lower chambers, respectively. The first chamber 516 is bound by the piston assembly 510, the upper sealhead 504, and the upper tube 204. The second chamber 518 is bound by the piston assembly 510, the lower sealhead 506, the upper tube 204, and the rod 508. The volumes of the first and second chambers 516, 518 change as the upper tube 204 moves up and down relative to the piston assembly 510. The first and second chambers 516, 518 are filled with a fluid. In this example, the seat post 200 is based on a pneumatic platform. Therefore, the first and second chambers 516, 518 can be filled with a pressurized gas, such as nitrogen or air. In other examples the first and second chambers 516, 518 can be filled with another type of compressible gas. The piston assembly 510 controls the flow of fluid (e.g., pressurized gas) across the piston 512 and between the first and second chambers 516, 518.

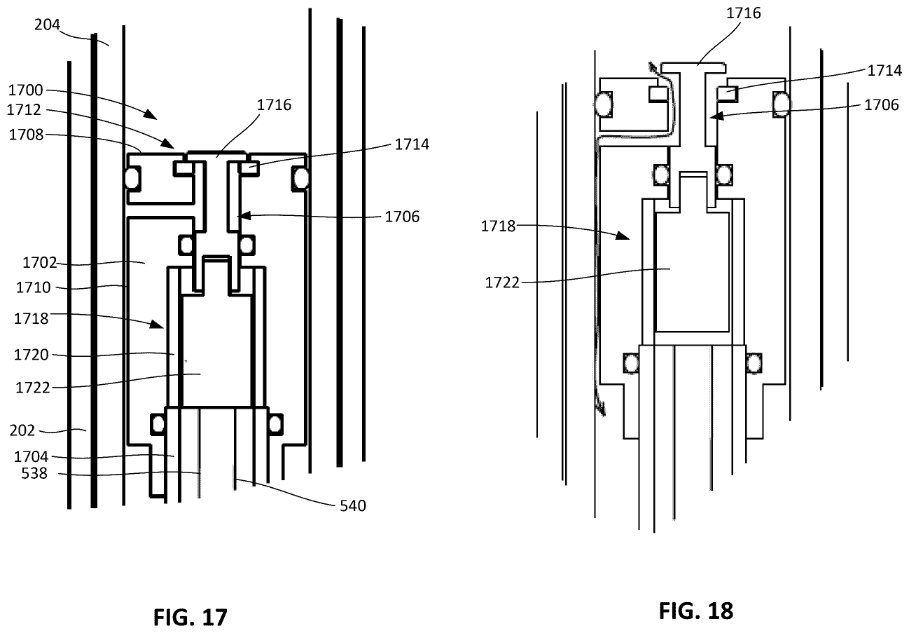

In the illustrated example of FIGS. 5 and 6, the seat post 200 includes a valve 520 and a valve actuator 522 (which may also be referred to as an electric actuator) to control the state of the valve 520. The valve actuator 522 can be activated or actuated to operate (e.g., switch) the valve 520 between the closed state and the and the open state. Although the present example describes the valve 520 as switchable between the closed state and the open state, it should be appreciated that various valves may be operated through and/or maintained at one or more intermediate states facilitating one or more intermediate levels of flow. In this example, the valve 520 and the valve actuator 522 are part of the piston assembly 510 and incorporated into and/or integrated with the piston 512. As such, the valve 520 is disposed fluidly between the first chamber 516 and the second chamber 518. In this example, the valve 520 is a poppet valve, which is a type of linear valve that includes a flow control member (e.g., a poppet) that is moveable in a linear direction to open or close the valve 520. However, in other examples, other types of valves can be used. The valve 520 can be operated (e.g., opened or closed) to control a fluid flow across the piston 512 between the first and second chambers 516, 518. In particular, the valve 520 is operable between a closed state and an open state. In the closed state, the valve 520 blocks the flow of fluid across the valve 520 (and the piston assembly 510) between the first and second chambers 516, 518, which maintains seat post 200 in its current position and, thus, maintains the lower and upper tubes 202, 204 in their current position. In the open state, the valve 520 enables the fluid to flow across the valve 520 (and the piston assembly 510) between the first and second chambers 516, 518, which enables the upper tube 204 to move relative to the lower tube 202 for adjusting the height of the seat 110 (FIG. 1). The valve actuator 522 can be activated to move the valve 520 between the open and closed states. In this example, the valve actuator 522 is an electric motor, such as a brushed, coreless direct-current (DC) motor. In other examples, other types of motors can be implemented. In other examples, the valve actuator 522 can be implemented by a solenoid, an example of which is shown in connection with FIGS. 17 and 18. Further, while in this example the valve actuator 522 is integrated into the piston assembly 510 in the upper tube 204, in other examples, the valve actuator 522 can be disposed in another location, such as attached to the lower end 210 of the lower tube 202.

Therefore, the seat post 200 includes a height control mechanism to selectively facilitate relative movement between the lower tube 202 and the upper tube 204 in an open state and to restrict relative movement between the lower tube 202 and the upper tube 204 and a closed state. In this example, the height control mechanism is implemented as the valve 520 and valve actuator 522. Therefore, the term height control mechanism can be used interchangeably with the valve 520 and the valve actuator 522. However, in other examples, other height control mechanisms can be implemented to control the relative movement between the lower and upper tubes 202, 204.

In some examples, the seat post 200 includes a valve 524 (e.g., a Schrader valve, a Presta valve) to enable a user to add air (or another pneumatic fluid) to the sealed pressure chamber 502 or vent air from the sealed pressure chamber 502. In this example, the valve 524 is incorporated into the upper sealhead 504. A user can remove the seat clamp 214 and access the valve 524 to add or remove pneumatic fluid to/from the sealed pressure chamber 502.

In the illustrated example of FIGS. 5 and 6, the first chamber 516 is a positive pressure chamber and the second chamber 518 is a negative pressure chamber. The first chamber 516 and the second chamber 518 are pressure sealed chambers. The lower tube 202 defines a third chamber 526 between the lower sealhead 506 and the lower end 210 of the lower tube 202. The third chamber 526 is considered a pressure control chamber. The volume of the third chamber 526 changes based on the actuated position. In some examples, the third chamber 526 is vented to the atmosphere (e.g., via openings in the lower cap assembly 211) and therefore contains air at atmospheric pressure. However, in other examples, the third chamber 526 is also a pressure sealed chamber (e.g., containing pressurized air or nitrogen). In such an example, the air in the third chamber 526 may be compressed as the upper tube 204 is moved downward. This compressed air can provide a biasing force to return the seat post 112 to the fully extended position. In other examples, the third chamber 526 can have other mechanisms for compensating for the change in volume, such as a floating piston or a deformable bladder. The first chamber 516, the second chamber 518, and the third chamber 526 may be any number of shapes and/or sizes. For example, the first chamber 516, the second chamber 518, and the third chamber 526 may be cylindrically shaped (e.g., with outer diameters between 27 millimeters (mm) and 35 mm, respectively) and may be sized for a particular maximum post adjustment (e.g., 150 mm).

As shown in FIGS. 5 and 6, the piston 512 has a first side 528 facing the upper sealhead 504 and a second side 530 opposite the first side 528 and facing the lower sealhead 506. An axial surface area (as viewed along the axis 206) of the first side 528 of the piston 512 is greater than an axial surface area of the second side 530 of the piston 512. This is because a portion of the axial surface area of the second side 530 is reduced by the cross-sectional area of the rod 508. When the valve 520 is in the closed state and the seat post 200 is in the fully extended position (FIG. 5), the first chamber 516 acts as a spring and is configured to bias the upper tube 204 towards the fully extended position of the seat post 200. The first side 528 and the second side 530 of the piston 512 are sized and shaped, and the first chamber 516 and the second chamber 518 are respectively pressurized when the seat post 200 is in the fully extended position, such that the gas within the first chamber 516 supports the weight of the rider. In some examples, the seat 110 sags less than 10 mm as a result of the weight of the rider on the seat 110 when the seat post 200 is in the fully extended position. The seat post 112 operates because the axial surface area of the first side 528 of the piston 512 versus a pneumatic pressure ratio between the first chamber 516 and the second chamber 518 holds up the rider based on the force calculation. This is also dependent on the volume of the second chamber 518 at the fully extended position of the seat post 200. In the illustrated example of FIG. 5, the volume of the first chamber 516 is greater than the volume of the second chamber 518 when the seat post 112 is in the fully extended position. In some examples, the volume of the second chamber 518 may be no more than twenty percent of the volume of the first chamber 516 when the seat post 112 is in the fully extended position. In other examples, the first and second chambers 516, 518 may have a different volume ratio in the fully extended position. For example, the volume of the second chamber 518 may be no more than ten percent, five percent, or three percent of the volume of the first chamber 516 when the seat post 200 is in the fully extended position. This makes the seat post 200 act like a zero negative pressure preloaded pneumatic spring. This is the principal that holds up the rider with a feel the rider experiences as being rigid. At the fully extended position of the seat post 200, the seat 110 may move a small amount, but this movement is typically not perceivable to the rider.

As an example operation, assume the seat post 200 is in the fully extended position shown in FIG. 5 and the rider desires to lower the seat 110 (FIG. 1). The rider presses the seat post actuator 113 (FIG. 1) on the handlebars 118 (FIG. 1). The controller 408 receives a signal from the seat post actuator 113. In response to receipt of the signal, the controller 408 activates the valve actuator 522 to open the valve 520, i.e., move the valve 520 from the closed state to the open state. In some examples, once the valve 520 reaches the open position (e.g., an end of range of the valve 520), the controller 408 can deactivate the valve actuator 522 and the valve 520 remains in the open state. In other examples, the controller 408 may continually supply power to the valve actuator 522 to maintain the valve 520 in the open state. When the valve 520 is open, a force can be applied downward on the seat 110 to compress the seat post 200. For example, the rider can sit (or partially sit) on the seat 110 to apply downward pressure with his/her bottom. This downward pressure forces fluid (e.g., pressurized gas) from the first chamber 516 to flow through the valve 520 and across the piston 512 and into the second chamber 518. This enables the upper tube 204 to move downward relative to the upper tube 204, thereby lowering the seat 110. As the upper tube 204 is moved downward, the volume of the first chamber 516 is reduced and the volume of the second chamber 518 is increased. The rider can move (e.g., lower) the seat 110 to any position between the fully extended position and a fully retracted position. FIG. 6 shows the seat post 200 as in an intermediate position between the position and the retracted position.

In some examples, the valve 520 is maintained in the open position until the seat post actuator 113 is released. In other examples, the valve 520 is closed automatically after a predetermined time period, examples of which are disclosed in further detail herein. The controller 408 activates the valve actuator 522 to close the valve 520, i.e., move the valve from the open state to the closed state. Once the valve 520 reaches the closed position (e.g., an end of range of the valve 520), the controller 408 can deactivate the valve actuator 522 and the valve 520 remains in the closed. When the valve 520 is closed, the fluid (e.g., pressurized gas) is prevented from flowing across the piston assembly 510 between the first chamber 516 and the second chamber 518. This limits or prevents further movement of the upper tube 204 relative to the lower tube 202. When the valve 520 is closed, the balance of forces in the system is such that the axial force acting on the first side 528 of the piston 512 is approximately equal to the axial force acting on the second side 530 of the piston 512. Using a compressible fluid such as air enables the pressure chamber to act as a compression spring when a downward force is applied on the upper tube 204. Therefore, when the rider sits on the seat 110, the seat post 200 can support the weight of the rider. In some examples, when the seat post 200 is in an intermediate position (between the extended position and the retracted position), the seat 110 may sag a small amount (e.g., 40 mm or less) as a result of the weight of the rider. The seat post 200 can be maintained at any position between the extended position and the retracted position. If the seat post 200 is moved to the retracted position, the seat clamp 214 contacts the upper end 208 of the lower tube 202 and/or the second sealhead 406 contacts the lower cap assembly 220. This provides a hard stop to prevent further movement. When the seat post 112 is in the retracted position, the seat 110 may not sag due to this hard stop.

When it is desired to raise the seat post 200, the rider presses on the seat post actuator 113 (FIG. 1), and the controller 408 (FIG. 4) activates the valve actuator 522 to open the valve 520. With no external downward force acting on the seat 110 (FIG. 1), the pressure in the first chamber 516 the upper tube 204 causes the upper tube 204 to move upward relative to the lower tube 202 back to the fully extended position. This is because the axial surface area of the first side 528 of the piston 512 is greater than the axial surface area on the second side 530 of the piston 512. As such, the force of the pressure in the first chamber 516 acting on the first side 528 of the piston 512 is larger than the force from the pressure in the second chamber 518 acting on the second side 530 of the piston 512. As a result, the upper tube 204 is forced upward to the fully extended position. As the upper tube 204 moves upward, fluid flows across the valve 520 from the second chamber 518 to the first chamber 516. Therefore, the axial force imbalance biases the seat post 200 towards the fully extended position. This enables the seat post 112 to automatically expand back to the fully extended position shown in FIG. 5. Therefore, the pressurized gas in the first chamber 516 biases the upper and lower tubes 204, 202 away from each other, and the pressurized gas in the second chamber 518 biases the upper and lower tubes 204, 202 toward each other. When the desired seat height is reached, the rider can release the seat post actuator 113 to close the valve and maintain the seat post 200 in the current position. In other examples, the controller 408 may automatically close the valve 520 after a predetermined time period. While in the example of FIGS. 5 and 6 the seal pressure chamber 502 and the piston assembly 510 with the valve 520 are disposed in the upper tube 204, in other examples, the seat post 200 can be configured such that the seal pressure chamber 502 is formed in the lower tube 202 and the piston assembly 510 with the valve 520 are disposed in the sealed pressure chamber 502 in the lower tube 202.

As disclosed above, the control module 216 includes the controller (FIG. 4), which is configured to control and operate the valve actuator 522 to open and close the valve 520. In the illustrated example of FIGS. 5 and 6, the control module 216 is located on the outer surface 223 of the lower tube 202, at or near the upper end 208 of the lower tube 202, while the valve actuator 522 is disposed in the upper tube 204. The seat post 200 can include one or more wires and/or electrical connections to form an electrical path between the control module 216 and the valve actuator 522. This enables power and/or command signals to be transferred between the control module 216 and the valve actuator 522. For example, as shown in FIGS. 5 and 6, the seat post 200 includes first and second wires 532, 534 disposed in the lower tube 202. In some examples, the first and second wires 532, 534 are positive and negative wires. The first and second wires 532, 534 are electrically coupled to the controller 408. The first and second wires 532, 534 extend through the lower tube 202 to the valve actuator 522. In other words, in this example, the first and second wires 532, 534 extend between the upper end 208 and the lower end 210 of the lower tube 202. Further, the seat post 200 also includes first and second inner tube wires 538, 540. The first and second inner tube wires 538, 540 are disposed in the rod 508 and extend between the lower cap assembly 211 and the valve actuator 522. The lower cap assembly 220 includes one or more electrical connectors or wire bridging to electrically couple the outer tube wires 532, 534 and the respective inner tube wires 538, 540. The outer and inner tube wires 532, 534, 538, 540 can be soldered or crimped to the electrical connectors in the lower cap assembly 220. Therefore, the outer tube wires 532, 534, the inner tube wires 538, 540, and the electrical connectors form an electrical path between the control module 216 and the valve actuator 522. As such, positive and negative electrical connections are formed between the controller 408 and the valve actuator 522. The controller 408 can activate the valve actuator 522 by electrically coupling (e.g., via a switch) the wires 532, 534 to the battery 404.

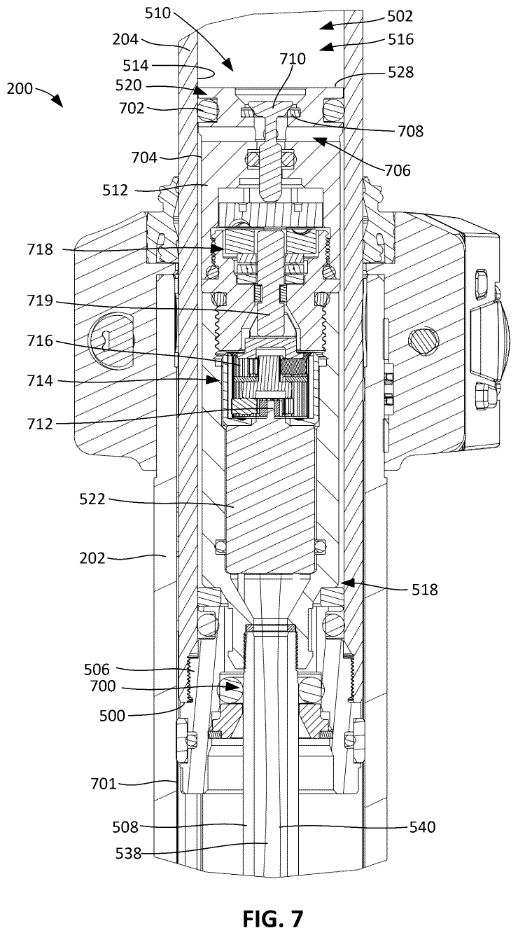

FIG. 7 is an enlarged view of the callout 542 of FIG. 5. As shown in FIG. 7, the lower sealhead 506 is threadably coupled to the lower end 500 of the upper tube 204 to seal the lower end of the sealed pressure chamber 502. The lower sealhead 506 is also sealed against and slidable along an inner surface 701 of the lower tube 202. The rod 508 extends through a channel 700 in the lower sealhead 506 and is coupled (e.g., threadably coupled) to the piston 512. The piston 512 can be constructed of one or multiple body portions that are coupled together.

In the illustrated example of FIG. 7, the piston assembly 510 includes a piston seal 702 (e.g., an o-ring) that is coupled to (e.g., disposed in a seal gland of) the piston 512 and in sealing contact with the inner surface 514 of the upper tube 204. The piston seal 702 is engaged with and seals against the inner surface 514 to prevent fluid leakage between the inner surface 514 of the upper tube 204 and an outer side surface 704 of the piston 512.

In the illustrated example of FIG. 7, the piston 512 defines a fluid passageway 706 extending between the first side 528 of the piston 512 and the outer side surface 704 of the piston 512. As such, the fluid passageway 706 fluidly connects the first chamber 516 and the second chamber 518. A seal ring 708 (also referred to as a seat) is disposed in the fluid passageway 706. In the illustrated example, the valve 520 includes a flow control member 710 (e.g., a poppet, a plug). The flow control member 710 is slidably disposed in the fluid passageway 706. In this example, the valve 520 is a linear valve. As such, the flow control member 710 is moveable in a linear direction between a closed position and an open position. In the closed position, which is shown in FIG. 7, the flow control member 710 is engaged with the seal ring 708 and blocks fluid flow through the fluid passageway 706. As such, fluid is prevented from flowing across the valve 520 (i.e., across the piston 512) between the first and second chambers 516, 518. In the open position, the flow control member 710 is moved upward such that the flow control member 710 is spaced from the seal ring 708 and therefore allows fluid flow through the fluid passageway 706 and across the valve 520 between the first and second chambers 516, 518. In this example, the valve 520 includes and/or is formed by the piston 512, the fluid passageway 706, the seal ring 708, and the flow control member 710. As such, the valve 420 is disposed in and/or formed at least partially by the piston 512. The valve 520 divides the upper tube 204 into the first chamber 516 and second chamber 518. In other examples, a seal ring may not be included. Instead, the flow control member 710 may directly engage and seal against a portion of the piston 512.

In the illustrated example, the valve actuator 522 is disposed in the piston 512. As shown in FIG. 7, the inner wires 538, 540 extend through the rod 508 and into the piston 512 and are electrically connected to the valve actuator 522. In this example, the valve actuator 522 is an electric motor having a rotatable output shaft 712. In the illustrated example, the piston assembly 510 includes a gear system 714 in the piston 512, operably coupled between the valve actuator 522 and the flow control member 710. The gear system 714 can include an arrangement of gears 716 a change a rotational speed (e.g., provide speed reduction) between the valve actuator 522 (electric motor) and the valve 520. In some examples, the gear system 714 is a planetary gear system, such as a two-stage planetary gear system, but in other examples can include one stage or more than two stages. In other examples, no gear system may be provided. Instead, a direct-drive configuration can be used.

In the illustrated example, the piston assembly 510 includes a cam assembly 718 that converts rotational motion to linear motion, such that rotation of the output shaft 712 of the valve actuator 522 (electric motor) causes linear movement of the flow control member 710 for opening or closing the valve 520. The piston assembly 510 includes a valve rod 719 coupled between the gear system 714 and the cam assembly 718. Rotation of the valve rod 719 in one direction causes the cam assembly 718 to move the flow control member 710 upward, and rotation of the valve rod 719 in the opposite direction causes the cam assembly 718 to move the flow control member 710 downward. Therefore, the valve actuator 522 (the motor) can be activated in one direction to move the flow control member 710 upward from the closed position to the open position, and can be activated in the opposite direction to move the flow control member 710 (or enable the flow control member 710 to move via a spring) to move from the open position to the closed position.

As discussed above, the valve 520 is operable between a closed state when the flow control member 710 is in the closed position and an open state when the flow control member 710 is moved to the open position. The open and closed states/positions may be defined by certain limits or stops. For example, the closed position occurs when the flow control member 710 engages the seal ring 708. In this position, the valve actuator 522 cannot further move the flow control member 710 down and, thus, forms a limit or stop. In some examples, the limit of the valve open position is defined by the cam assembly 718. For example, the cam assembly 718 may include two cams with balls between the cams. The balls may rest within certain grooves in the cams when the open position is reached, which prevents the cams from being further rotated.

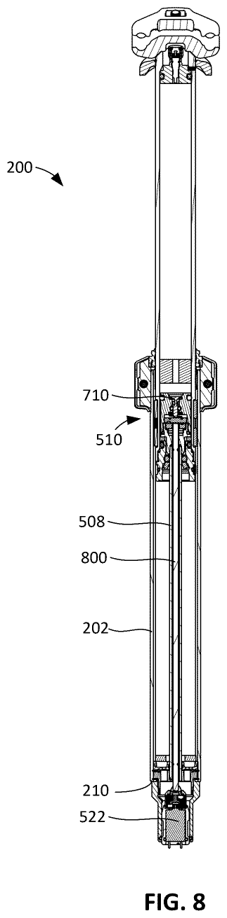

While in the example of FIG. 7 the valve actuator 522 is disposed in the piston assembly 510 in the upper tube 204, in other examples, the valve actuator 522 can be disposed in another location. For example, FIG. 8 is a cross-sectional view of the seat post 200 in which the valve actuator 522 is disposed at the lower end 210 of the lower tube 202. In this example, the seat post 200 includes a valve rod 800. The valve rod 800 is disposed in and extends through the rod 508. The valve rod 800 is coupled between the valve actuator 522 and the piston assembly 510. The valve actuator 522 can be activated to rotate the valve rod 800, which causes the flow control member 710 to move up or down between the open and closed positions. In the example of FIG. 8, the actuator 522 is coupled to but disposed outside of the lower tube 202. In other examples, the actuator 522 can be disposed in the lower tube 202 at or near the lower end 210.

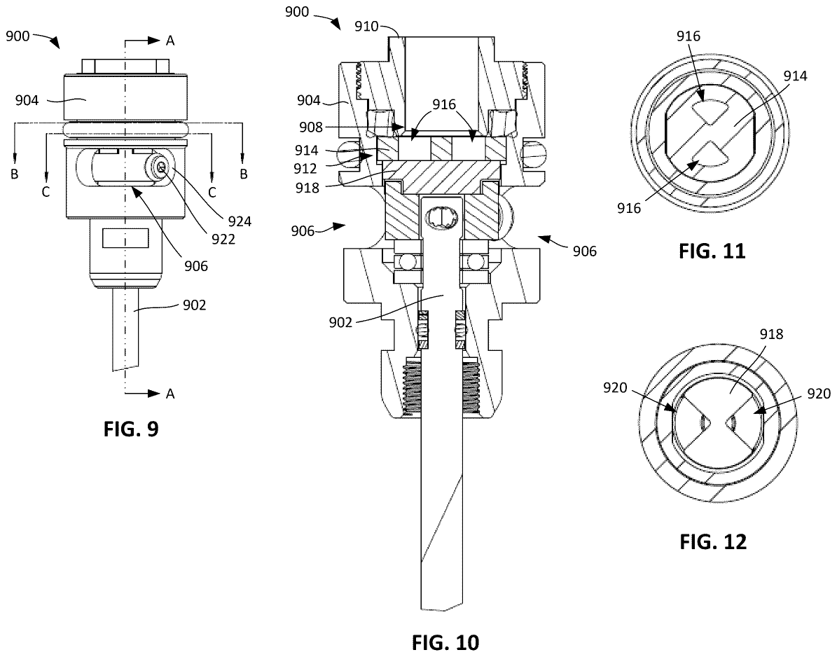

In some examples, instead of a linear valve, the seat post 200 can include another type of valve, such as a rotary valve. FIGS. 9-12 illustrate an example piston assembly 900 having a rotary valve. The piston assembly 900 can be implemented as the piston assembly 510 in the seat post 200. FIG. 9 is a side view of the piston assembly 900 and a valve rod 902 that can be used to operate the internal valve. FIG. 10 is a cross-sectional view of the piston assembly 900 and the valve rod 902 taken along line A-A of FIG. 9. FIG. 11 is a cross-sectional view taken along line B-B of FIG. 9 showing an axial view (e.g., a top view) of a fixed disc. FIG. 12 is a cross-sectional view taken along line C-C of FIG. 9 showing an axial view (e.g., a top view) of a rotatable disc in a closed position.

The piston assembly 900 includes a piston 904. The piston 904 includes radial openings 906 in an outer surface of the piston 904. The piston 904 defines a fluid passageway 908 between a top side 910 of the piston 904 and the radial openings 906. The piston assembly 900 includes a valve 912 formed by the fluid passageway 908. The valve 912 includes a fixed disc 914 disposed in the fluid passageway 908. The fixed disc 914 has openings 916 (e.g., channel, flow paths). The valve 912 also includes a flow control member, which, in this example, is a rotary disc 918. The rotary disc 918 is disposed in the fluid passageway 908 and engaged with the fixed disc 914. The rotatable disc 916 has notches 920 (FIG. 12). The valve rod 902 extends into the piston 904 and is coupled to the rotary disc 918. The valve rod 902 can be rotated by the valve actuator 522 to rotate the rotary disc 918 between a closed position and an open position. In FIGS. 9-12 the rotary disc 918 is in the closed position. When the rotary disc 918 is in the closed position, the notches 920 do not overlap with the openings 916 in the axial direction and, thus, the openings 916 are blocked by the rotatable disc 820. This prevents or blocks fluid flow across the fixed disc 914 and the rotary disc 918 and between the first and second chambers 516, 518 (FIG. 5).

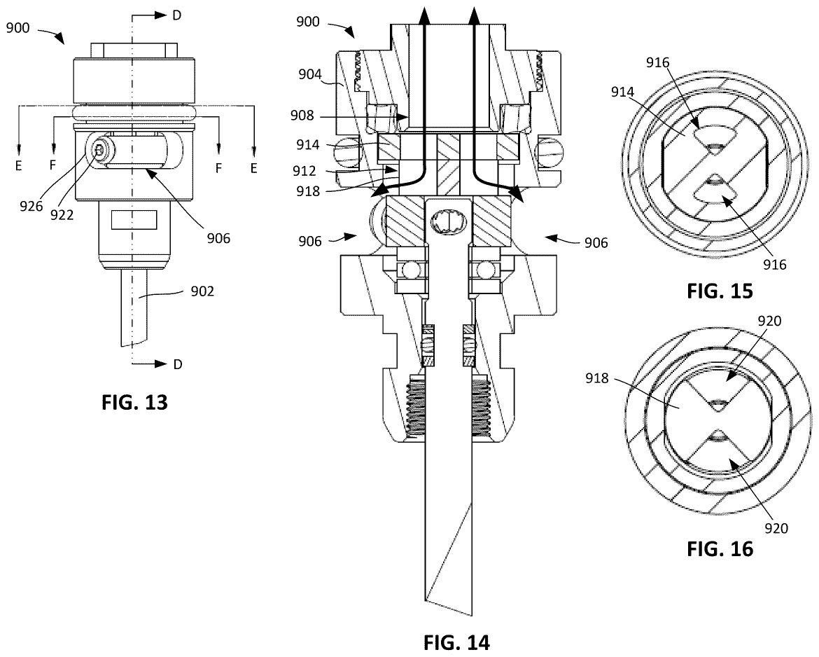

FIGS. 13-16 are similar views of the piston assembly 900 and the valve rod 902 as FIGS. 9-12, but showing the valve 912 in the open state. In particular, the valve rod 902 has been rotated about a quarter turn (e.g., 90°) by the valve actuator 522 (FIG. 5) and moved the rotary disc 918 to the open position. As shown in FIGS. 15 and 16, the notches 920 in the rotary disc 918 are at least partially overlapping with the openings 916 in the fixed disc 914 in the axial direction. As such, fluid can flow in the axal direction through the openings 916 in the fixed disc 914 and between the first and second chambers 516, 518 (FIG. 5).

As shown in FIGS. 9 and 13, the piston assembly 900 includes a stop bolt 922 that extends through one of the radial openings 906 and is coupled to the valve rod 902. As shown in FIG. 9, when the valve 912 is in the closed position, the stop bolt 922 engages a first end 924 (e.g., a stop surface) of the radial opening 906. This limits or prevents the valve rod 902 (and, thus, the rotary disc 918) from being rotated further in the counter-clockwise direction (when viewed from FIGS. 11 and 12). As such, this forms a stop when the valve 912 is in the closed state. Similarly, when the valve 912 is rotated a quarter turn to the open position shown in FIG. 13, the stop bolt 922 engages a second end 926 of the radial open 906. This limits or prevents the valve rod 902 (and, thus, the rotary disc 918) from being rotated further in the clockwise direction (when viewed from FIGS. 15 and 16). As such, this forms a stop when the valve 912 is in the open state.

As disclosed above, in some examples, the valve actuator 522 can be implemented by an electric motor. In other examples, the valve actuator 522 can be implemented by a solenoid. For example, FIG. 17 illustrates an example piston assembly 1700 with a linear valve and a solenoid. The piston assembly 1700 can be implemented as the piston assembly 510 in the seat post 200. The piston assembly 1700 includes a piston 1702 coupled (e.g., threadably coupled) to a rod 1704 (which may correspond to the rod 508). The piston 1702 defines a fluid passageway 1706 between a top side 1708 of the piston 1702 and an outer surface 1710 of the piston 1702. The piston assembly 1700 includes a valve 1712 to control the flow of fluid across the piston assembly 1700. The valve 1712 includes a seal ring 1714 (which may be referred to as a seat) in the fluid passageway 1706. The valve 1712 includes a flow control member 1716 slidably disposed in the fluid passageway 1706. The flow control member 1716 is moveable in a linear direction (up or down in FIG. 17) between a closed position and an open position. In the closed position, which is shown in FIG. 17, the flow control member 1716 is engaged with the seal ring 1714, which blocks fluid flow through the fluid passageway 1706 and therefore blocks fluid flow between the first and second chambers 516, 518. FIG. 18 shows the flow control member as moved to the open position. In FIG. 18, the flow control member 1716 has been moved upward and is now spaced from the seal ring 1714, which enables fluid flow through the fluid passageway 1706 between the first and second chambers 516, 518.

In this example, the piston assembly 1700 includes a solenoid 1718 disposed in the piston 1702. The inner wires 538, 540 are connected to the solenoid 1718, which enable the controller 408 (FIG. 4) to activate or deactivate the solenoid 1718. The solenoid 1718 includes a core with coil 1720 and an armature 1722 (which may also be referred to as a plunger). In this example, when the solenoid 1718 is activated, the armature 1722 is moved in the upward (first) direction to move the flow control member from the closed position to the open position. When the solenoid 1718 is deactivated, the armature 1722 and the flow control member 1716 move downward such that flow control member 1716 is returned to the closed position and engaged with the seal ring 1714. In some examples, the solenoid 1718 can include a return spring to bias the armature 1722 downward. However, in other examples, the solenoid 1718 does not include a return spring. Instead, when the solenoid 1718 is deactivated, the air pressure differential on the flow control member 1716 biases the flow control member 1716 and the armature 1722 in the downward (second) direction. As such, when the solenoid 1718 is deactivated, the flow control member 1716 is moved downward and the valve 1712 is closed. In some examples, the closed position is defined by a limit when the flow control member 1716 engages the seal ring 1714, and the open position is defined by a limit when the armature 1722 engages a shoulder or stop surface in the piston 1702.

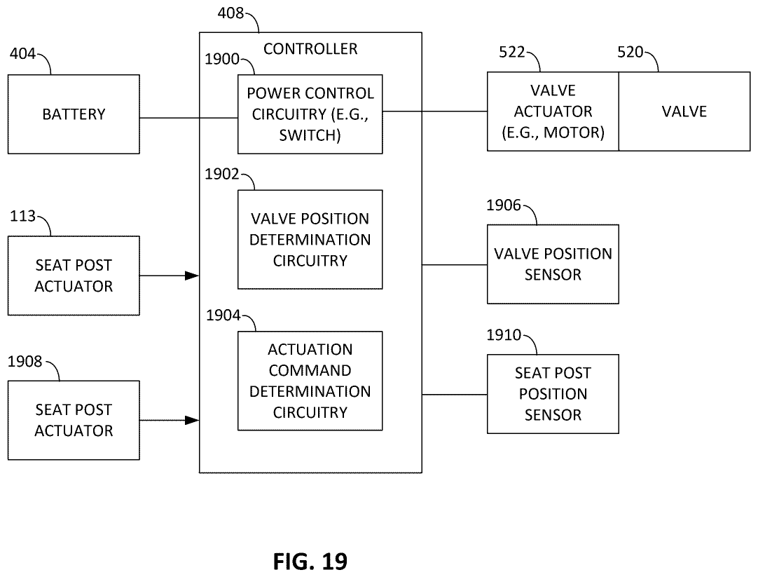

FIG. 19 is a block diagram of an example implementation of the controller 408 of FIG. 4. The controller 408 is configured to activate a valve actuator and control the state of a valve. Example operations are described in connection with the valve actuator 522 (electric motor) and the valve 520 (linear valve), but can similarly be implemented in connection with any of the other example valve actuators and valves disclosed herein.

The controller 408 and, more specifically, circuitry blocks 1900-1904 of the controller 408 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the controller 408 and, more specifically, the circuitry blocks 1900-1904, may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 19 may, thus, be instantiated at the same or different times. Some or all of the circuitry of FIG. 19 may be instantiated, for example, in one or more threads executing concurrently on hardware and/or in series on hardware. Moreover, in some examples, some or all of the circuitry of FIG. 19 may be implemented by microprocessor circuitry executing instructions and/or FPGA circuitry performing operations to implement one or more virtual machines and/or containers.

The controller 408 is electrically coupled (e.g., via one or more wires, traces, etc.) to a power source, such as the battery 404. The controller 408 is also electrically coupled to the valve actuator 522. For example, as disclosed above, the controller 408 is electrically coupled to the valve actuator 522 via the wires 532, 534, 538, 540 (FIG. 5). As shown in FIG. 19, the controller includes power control circuitry 1900. The power control circuitry 1900 can activate or deactivate the valve actuator 522 by controlling the supply of electrical power from the battery 404 to the valve actuator 522. In particular, the power control circuitry 1900 includes one or more switches (e.g., transistors). The switch(es) can be closed to electrically couple (e.g., form a closed circuitry between) the battery 404 to the valve actuator 522 and thereby activate the valve actuator 522, or can be opened to disconnect the valve actuator 522 from the battery 404 to thereby deactivate the valve actuator 522.

In some examples, once the valve 520 is in the open or closed state, the valve 520 remains in the opened state due to latching or pressure bias. Therefore, when opening or closing the valve 520, the controller 408 is configured to activate the valve actuator 522 until the flow control member 710 reaches the open or closed position, and then deactivates the valve actuator 522. The controller 408 includes valve position determination circuitry 1902 to determine the state of the valve 520. In some examples, the valve position determination circuitry 1902 determines the state of the valve 520 by detecting the position of the flow control member 710. For example, the seat post 200 can include a valve position sensor 1906, such as a positional encoder, to measure or detect the position of the flow control member 710. The valve position determination circuitry 1902 receives signals from the valve position sensor 1906 and determines the position of the flow control member 710 (and, thus, the state of the valve 520) based on the signals. Additionally or alternatively, in some examples, the valve position determination circuitry 1902 can determine the position of the flow control member 710 (and, thus, the state of the valve 520) based on a measured current flow to the valve actuator 522. For example, the power control circuitry 1900 can include a resistor or another current sensing element or circuit to measure the current flow to the valve actuator 522. The valve actuator 522 draws a certain amount of current that changes throughout the actuation of the valve 520. The changes (e.g., spikes) in the current draw can be used to determine when the flow control member 710 is at different positions. Additionally or alternatively, in some examples, the valve position determination circuitry 1902 can determine flow control member 710 is in the open position or closed based on an elapsed time (e.g., 100 ms) after the valve actuator 522 is initially activated. For example, the valve position determine circuitry 1902 can measure the amount of time since the initial activation of the valve actuator 522. After a certain elapsed time (e.g., 100 ms), the valve position determination circuitry 1902 determines the flow control member 710 has moved to the open position or the closed position.

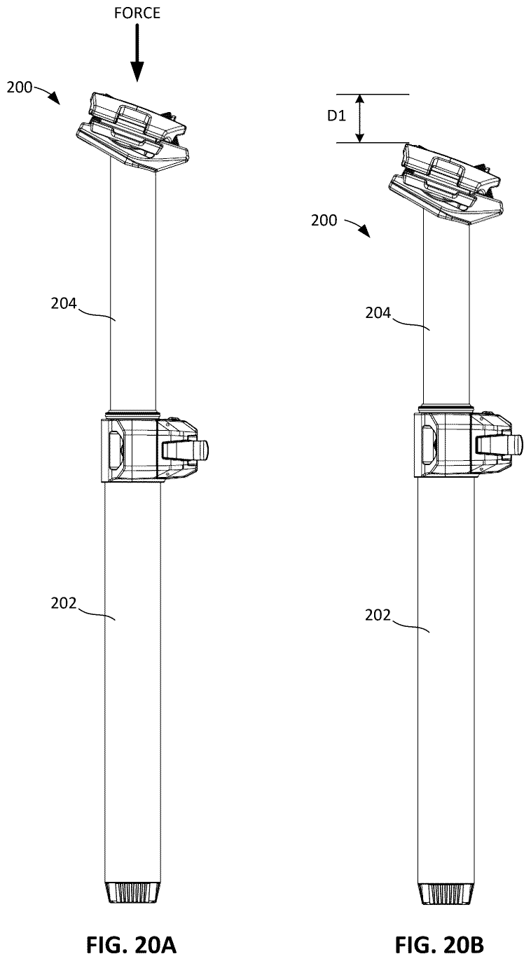

In some examples, the controller 408 is configured to actuate the valve 520 to open and close relatively quickly to make a small adjustment in the height of the seat 110 (FIG. 1). As disclosed herein, a rider may desire to lower or raise the seat 110 a small amount (e.g., 1 inch). By quickly opening and closing the valve 520, the seat post 200 can only be contracted (shortened) or expanded (lengthened) a small amount. For example, if the rider desires to lower the seat 110, the rider can activate (e.g., press) seat post actuator 113 while applying a downward force on the seat post 200, such as by sitting on the seat 110. The controller 408 receives the signal and activates the valve actuator 522 to open the valve 520, and automatically closes the valve 520 after a predetermined time period. The valve 520 is automatically closed independent of any further operations by the rider. In other words, even if the rider continues to hold (e.g., press) the seat post actuator 113, the controller 408 still automatically closes the valve 520. The predetermined time period may be relatively short. In some examples, the predetermined time period is less than 500 ms. In some examples, the predetermined time period is between 20 ms and 100 ms. As a result, because the valve 520 is only open for a short period of time, the seat post 200 only has a short period of time to contract, which results in a small change in height in the seat 110. For example, FIGS. 20A and 20B show an example in which the seat post 200 has been lowered by a distance D1. The distance D1 is a relatively small, incremental change in height. After the seat post height is changed, the rider can press the seat post actuator 113 again to cause another incremental change in height (e.g., reduction by distance D1). The rider can press the seat post actuator 113 multiple times in a row, where each press results in an incremental reduction in the seat height. The same operation can be performed to raise the height of the seat 110. This quick opening/closing of the valve 520 enables the rider to easily and quickly adjust the height of the seat 110.

The distance D1 that the seat post 200 is shortened or lengthened is based on the predetermined time that the valve 520 is open. For example, based on the predetermined time, the seat post 200 may contract only 1 inch. The controller 408 can be configured to implement longer or shorter times depending on the desired change in height, i.e., a longer predetermined time results in a larger change in height, whereas a shorter predetermined time results in a smaller change in height. In some instances, the controller 408 may be preprogrammed by the manufacturer to implement a certain predetermined time period. In some examples, the predetermined time period is adjustable based on at least one environmental or user setting. In some examples, the predetermined time period can be set and/or changed by the end user (e.g., via a button or other user input on the seat post 200). Additionally or alternatively, the controller 408 may automatically adjust the predetermined time period over time or based on a number of cycles. For instance, the controller 408 can track the count or number of cycles of the valve 520 (e.g., which may be stored in a memory). The controller 408 may adjust (e.g., shorten, lengthen) the predetermined time period after a certain number of cycles. This helps to account for fouling and/or changes in seal squeeze, lubrication state (e.g., viscosity), ingestion of dirt, and/or other environmental changes that affect the opening and closing times and forces. Additionally or alternatively, the controller 408 may adjust the predetermined time period based on temperature, because the ambient temperature can affect the valve opening and closing times and/or fluid flow times. Therefore, in some examples, the controller 408 can receive temperature measurements from a temperature sensor.

In some examples, the predetermined time period is measured from receipt of the control signal. As such, in some examples, the controller 408 is configured to automatically close the valve 520 after a predetermined time period (e.g., 500 ms) measured from receipt of the control signal. Therefore, upon receipt of a control signal from the seat post actuator 113, the controller 408 controls (e.g., activates) the valve actuator 522 to open the valve 520, and then automatically, after the predetermined time period from receiving the control signal, controls (e.g., activates) the valve actuator 522 to close the valve 520. The predetermined time period may be a relatively short time period (e.g., 500 ms or less than 500 ms), but still long enough to ensure the valve is fully opened (and maintained for a certain hold time) before closing the valve 520. This technique avoids the need for position determination circuity, which can reduce complexities and costs associated with the seat post 200. Therefore, in some examples the seat post 200 may not include any valve position determination means.

The predetermined time period may be selected to account for the valve opening time, any hold open time, and the valve closing time. As described in the examples of this paragraph, the predetermined time period may be defined in various ways to include all or part of the valve open and/or valve close times. For example, the predetermined time period may begin with receiving of the control signal. In other examples, the predetermined time period may begin with the last moment that the valve is closed and may end with the last moment that the valve is open during the valve cycling operation described herein. In some examples, the valve opening time may take up a relatively large portion of the predetermined time period. For example, a first time period is defined between receiving the control signal and the flow control member 710 achieving the open position, and a second time period is defined as a hold time between when the flow control member 710 achieves the open position and when the valve actuator 522 is activated to start closing the valve 520 (i.e., move the flow control member 710 from the open position to the closed position). The sum of the first time period and second time period form the predetermined time period. In some examples, the first time period (i.e., the valve opening operation) is at least 5% of the predetermined time period. For example, if the predetermined time period is about 500 ms, the first time period is at least 25 ms. In other examples, the first time period can be different lengths. For example, the first time period can be 5%, 10%, 20%, 30%, 40%, 50%, 60%, 70%, 80%, or 90% of the predetermined time period.

In some examples, if the predetermined time period is relatively short, the controller 408 may start closing the valve 520 before the valve 520 has even reached the fully open position. In other words, the valve 520 may only be partially opened before the closing operation begins. However, because of the inertia of the valve components, electrical inductance of electrical components, and other factors, there may be a delay between when the controller 408 provides current and when the valve 520 actually operates. Therefore, even if the predetermined time period is relatively small time (or even zero), the valve 520 may still be open for a small amount of time. Further, in some instances, it may be desirable for the controller 408 to close the valve 520 before it reaches the fully open position.

In other examples, the controller 408 may be configured to automatically close the valve 520 only after the valve position determination circuitry 1902 determines the valve 520 has reached a certain open position, such as fully open or partially open. In other words, once the valve 520 is determined to be at a certain open position, the controller 408 automatically closes the valve 520 after a predetermined time period (e.g., 500 ms). In some examples, the technique is advantageous because the valve opening time may take different amounts of time depending on temperature, forces, and other factors. As such, this technique ensures the valve 520 reaches a certain open position before beginning to close the valve 520.

In some examples, the controller 408 is configured to operate in different modes to perform different operations. For example, the controller 408 may operate in first mode that represents an operating mode where the valve 520 is held open the entire time the seat post actuator 113 is activated. This allows the rider to manually move the seat post 200 to any position between the extended position and the retracted position. The controller 408 may also operate in a second mode, where the controller 408 only opens the valve 520 for a short period of time and then automatically closes the valve 520 as disclosed above. This enables the seat post 200 to be adjusted a small, incremental amount, such as by 1 inch.

In some examples, the controller 408 is configured to operate in the first mode or the second mode based on a type of actuation command received at the controller 408. For example, if the controller 408 receives a first type of actuation command, the controller 408 operates in the first mode, and if the controller 408 receives a second type of actuation command, the controller 408 operates in the second mode. The controller 408 includes actuation command determination circuitry 1904 that determines whether an actuation command is a first type of action command or a second type of actuation. In some examples, the first and second types of actuation commands can be from the same device, such as from the seat post actuator 113. In some examples, the first type of actuation command corresponds to a continuous activation of the seat post actuator 113 for a first amount of time, and the second type of actuation command corresponds to a continuous activation of the seat post actuator 113 for a second amount of time that is shorter than the first amount of time. For example, if the seat post actuator 113 is activated (e.g., pressed) and held for a longer period of time, the controller 408 operates in the first mode, whereas if the seat post actuator 113 is quickly activated and released, the controller 408 operates in the second mode. In some examples, the actuation command determination circuitry 1904 determines whether an actuation command is the first type or the second type based on the amount of time the seat post actuator 113 is activated (e.g., pressed). For example, the controller 408 may compare the activation time (e.g., hold time) to a threshold (e.g., 50 ms). If the activation time is greater than the threshold, the actuation command is determined to be the first type and the first mode is implemented, whereas if the hold time is less than the threshold, the actuation command is determined to be the second type and the second mode is implemented.

In another example, the seat post 200 can include more than one seat post actuator to trigger the different modes. For example, there may be a first seat post actuator 113 and a second seat post actuator 1908. In some examples, the second seat post actuator 1908 is also mounted on the handlebars 118, and can communicate via wired or less connection with the controller 408. The actuation command determination circuitry 1904 can distinguish between a command (e.g., a signal) from the first seat post actuator 113 and a command (e.g., a signal) from the second seat post actuator 1908. Therefore, the first type of actuation command corresponds to the first seat post actuator 113 and the second type of actuation command corresponds to the second seat post actuator 1908. If the rider activates the first seat post actuator 113, the controller 408 operates in the first mode and holds the valve 520 open the entire time the first seat post actuator 113 is activated. If the rider activates the second seat post actuator 1908, the controller 408 operates in the second mode where the valve 520 is opened and then automatically closed after the predetermined time. In some examples, the first and second seat post actuators 113, 1908 are two buttons on the same module or interface. In other examples, the first and second seat post actuators 113, 1908 can be completely separate actuators. The seat post actuators 113, 1908 can be, for example, buttons, levers, or twist grip actuators, for example.

In another example, the second mode can be triggered by activation of the seat post actuator 113 in combination with another actuator. For example, the second mode can be triggered if the seat post actuator 113 is activated at the same time as a suspension control actuator that is also on the handlebars.

In some examples, the seat post 200 can be operated in a suspension mode that enables some movement (retraction or extension) of the seat post 200 to help absorb shocks and vibrations. The suspension mode corresponds to a certain height or length of the seat post 200, referred to herein as a suspension position. In particular, in the suspension position, the seat post 200 is at an intermediate height or length that is greater than the minimum length (corresponding to the retracted position) of the seat post 200 and less than the maximum length (corresponding to the extended position shown in FIGS. 2 and 5) of the seat post 200. In some examples, the intermediate length (the suspension position) may be half-way (e.g., ±10%) between the minimum length and the maximum length. For example, the suspension position may be similar to the position shown in FIGS. 3 and 6. As disclosed above, when the seat post 200 is in the extended position (corresponding to maximum length) and the valve 520 is closed, there is relatively little if any sag because of the large pressure differential between the chambers 516, 518. Further, when the seat post 200 is in the retracted position (corresponding to minimum length), there is a hard stop that limits further movement. As such, the seat post 200 is relatively stiff when in the extended position or the retracted position. However, when the seat post 200 is at the intermediate length corresponding to the suspension position, a larger amount of sag (e.g., 5 mm) can occur because there is less pressure differential between the chambers 516, 518. In some examples, a suspension sag value defined at the suspension position is greater than an extended sag value defined at the extended position. Therefore, when the seat post 200 is in the suspension position, a larger amount of sag (contraction) and/or extension can occur, which helps absorb some of the shocks and vibrations encountered by the bicycle.

In some examples, the controller 408 is configured to operate in a first mode or a second mode. The first mode that represents an operating mode where the valve 520 is held open the entire time the seat post actuator 113 is activated. This allows the rider to manually move the seat post 200 to any position between the fully extended position and the fully contracted position. The second mode corresponds to the suspension mode, wherein the seat post 200 is moved to and held at the suspension position. For example, assuming the rider activates the second mode while the seat post 200 is fully extended and the rider is sitting on the seat 110, the controller 408 opens the valve 520 such that the seat post 200 can contract or shorten. Once the seat post 200 reaches the suspension position (i.e., the intermediate length), the controller 408 closes the valve 520 to lock the seat post 200 in the suspension position. As another example scenario, assuming the rider activates the second mode while the seat post 200 is fully retracted and the rider is not sitting on the seat 110, the controller 408 opens the valve 520 such that the seat post 200 can expand or length. Once the seat post 200 reaches the suspension position (i.e., the intermediate length), the controller 4089 closes the valve 520 to lock the seat post 200 in the suspension position. Therefore, in the second (suspension) mode, the controller 408 is configured to open the valve 520 to enable the seat post 200 to lengthen or shorten and then automatically close the valve 520 when the seat post 200 reaches the suspension position. Therefore, when the actuation command is a first type of actuation command, the controller 408 facilitates momentary user control of the height control mechanism (e.g., the valve 520), and when the actuation command is the second type of actuation command, the controller facilitates automatic achievement of a suspension mode with the height control mechanism. In some examples, the seat post 200 includes a seat post position sensor 1910 (FIG. 19) to detect the location or position of the lower and upper tubes 202, 204 relative to each other. The controller 408 uses the measurements from the seat post position sensor 1910 to determine the position or height of the seat post 200.

While an example manner of implementing the controller 408 of FIG. 4 is illustrated in FIG. 19, one or more of the elements, processes, and/or devices illustrated in FIG. 19 may be combined, divided, re-arranged, omitted, eliminated, and/or implemented in any other way. Further, the example power control circuitry 1900, the example valve position determination circuitry 1902, the example actuation command determination circuitry 1904, and/or, more generally, the example controller 408 of FIG. 19, may be implemented by hardware alone or by hardware in combination with software and/or firmware. Thus, for example, any of the example power control circuitry 1900, the example valve position determination circuitry 1902, the example actuation command determination circuitry 1904, and/or, more generally, the example controller 408, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example controller 408 of FIG. 19 may include one or more elements, processes, and/or devices in addition to, or instead of, those illustrated in FIG. 19, and/or may include more than one of any or all of the illustrated elements, processes and devices.

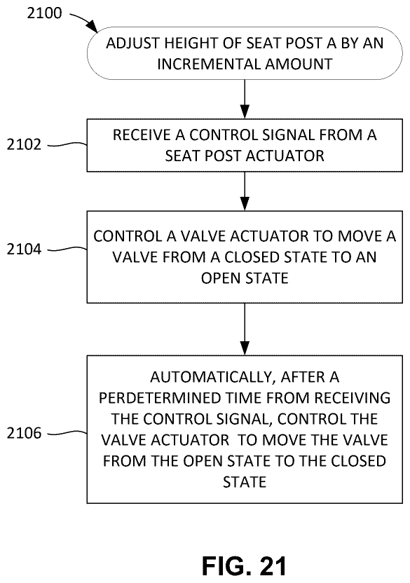

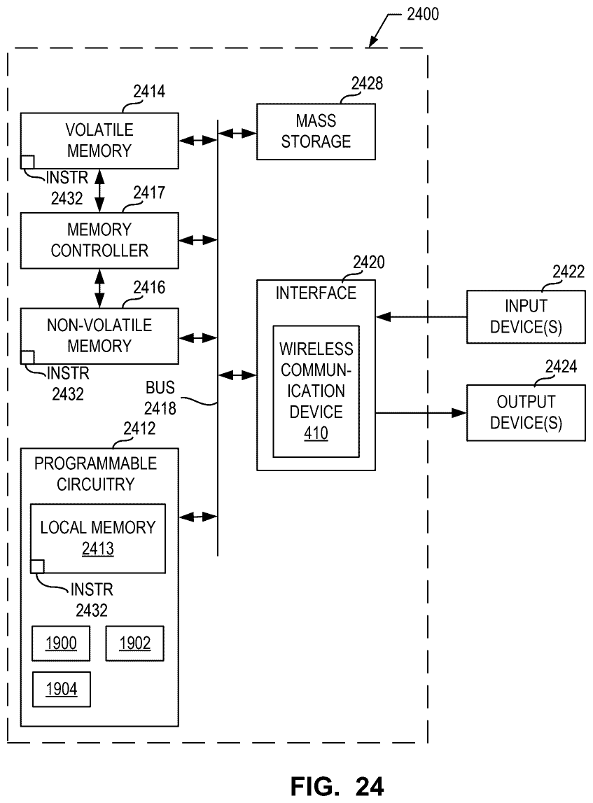

Flowchart(s) representative of example machine readable instructions, which may be executed by programmable circuitry to implement and/or instantiate the controller 408 of FIG. 19 and/or representative of example operations which may be performed by programmable circuitry to implement and/or instantiate the controller 408 of FIG. 19, are shown in FIGS. 21-23. The machine readable instructions may be one or more executable programs or portion(s) of one or more executable programs for execution by programmable circuitry such as the programmable circuitry 2412 shown in the example processor platform 2400 discussed below in connection with FIG. 24. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). Further, although the example program is described with reference to the flowchart(s) illustrated in FIGS. 21-23, many other methods of implementing the example controller 408 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above

As mentioned above, the example operations of FIGS. 21-23 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 21 is a flowchart representative of example machine readable instructions and/or example operations 2100 that may be executed, instantiated, and/or performed by programmable circuitry to adjust the height of a seat post by an incremental amount. The example operations 2100 are described in connection with the height adjustable seat post 200 with the linear valve 520 and the valve actuator 522 (i.e., an electric motor) shown in FIGS. 5-7. However, the example operations 3000 can be similarly performed in connection with the other example valves and valve actuators disclosed herein.

At block 2102, the controller 408 waits for a control signal from the seat post actuator 113. When a rider desires to adjust the height of the seat 110, the rider activates (e.g., presses) the seat post actuator 113, and the seat post actuator 113 sends a control signal to the controller 408. The seat post actuator 113 may communicate wirelessly or via a wired connection with the controller 408. The controller 408 receives the control signal, which indicates the seat post actuator 113 has been activated.

In response to receipt of the control signal indicating the seat post actuator 113 has been activated, the controller 408, at block 2104, controls the valve actuator 522 to move the valve 520 from the closed state to the open state. In particular, the power control circuitry 1900 activates the valve actuator 522 to move the flow control member 710 from the closed position to the open position. When the valve 520 is opened, fluid can flow across the valve 520 between the first and second chambers 516, 518. As such, when the valve 520 is open, the seat post 200 can be expanded (lengthened) or contracted (shortened). In some examples, once the flow controller member 710 is in the open position (e.g., determined by the valve position determination circuitry 1902), the power control circuitry 1900 deactivates the valve actuator 522, and the flow control member 710 remains in the open position. In other examples, based on the type of valve, the valve actuator 522 may remain activated to hold the flow control member 710 in the open position.

At block 2106, the controller 408 automatically, after a predetermined time period from receiving the control signal, controls the valve actuator to move the valve 520 from the open state to the closed state. For example, the power control circuitry 1900 can activate the valve actuator 522 to move the flow control member 710 from the open position to the closed position, and then deactivates the valve actuator 520 once the flow control member 710 is in the closed position. In other examples, such as where the valve actuator 522 is implemented as a solenoid, the flow control member 710 is biased to return to the closed position. In such an example, the power control circuitry 1900 deactivates the solenoid to allow the flow control member to return to the closed position. The automatic closing of the valve 520 is independent of any rider input. Therefore, even if the rider continues to hold the seat post actuator 113 or releases the seat post actuator 113, the valve 520 is still automatically closed after the predetermined time period. In some examples, the predetermined time period is less than 500 ms. As a result of the quick opening and closing, the seat post 200 height is changed by a small, incremental amount. In other examples, the predetermined time period can be longer or shorter to result in smaller or larger changes in height. If a rider desires to adjust the height further, the rider can activate the seat post actuator 113 again, and the example process 2100 is repeated.

In other examples, the controller 408 may automatically close the valve after a predetermined time period from when the valve 520 reaches the open state. In some examples, the valve position determination circuitry 1902 determines the flow control member 710 is in the open position based on a signal from the valve position sensor 1906. In another example, the valve position determination circuitry 1902 determines the flow control member 710 is in the open position based on a measured current flow to the valve actuator 522. In another example, the valve position determination circuitry 1902 determines the flow control member 710 is in the open position based on an elapsed time after the valve actuator 522 is initially activated to open the valve 520. For example, if the elapsed time is greater than a threshold time, the valve position determination circuitry 1902 determines the flow control member 710 is in the open position (i.e., the valve 520 has been opened). In some examples, once the flow controller member 710 is in the open position, the power control circuitry 1900 deactivates the valve actuator 522, and the flow control member 710 remains in the open position. In other examples, based on the type of valve, the valve actuator 522 may remain activated to hold the flow control member 710 in the open position.

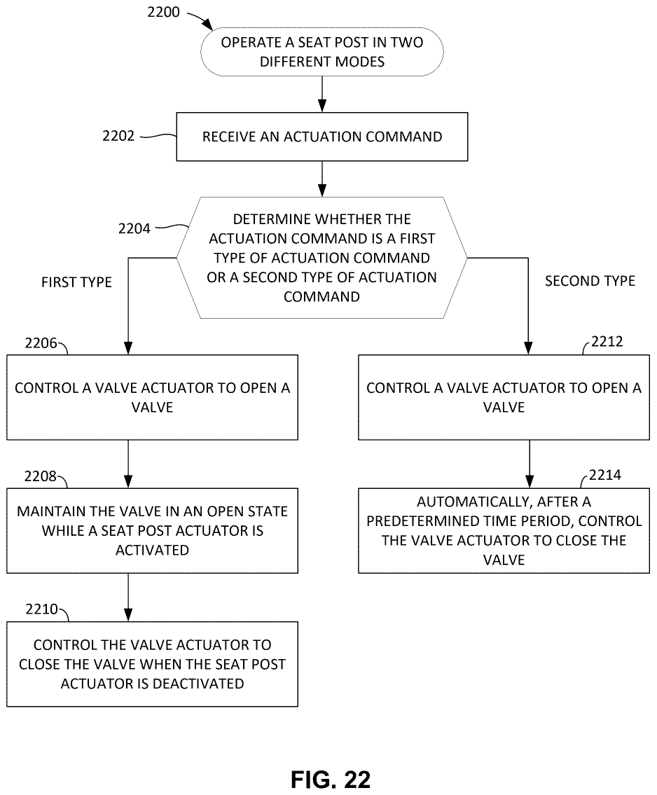

FIG. 22 is a flowchart representative of example machine readable instructions and/or example operations 2200 that may be executed, instantiated, and/or performed by programmable circuitry to operate a seat post in two different modes that enable adjustment of the seat post height. The example operations 2200 are described in connection with the height adjustable seat post 200 with the linear valve 520 and the valve actuator 522 (i.e., an electric motor) shown in FIGS. 5-7. However, the example operations 2200 can be similarly performed in connection with the other example valves and actuators disclosed herein.

At block 2202, the controller 408 waits for an actuation command (e.g., a control signal) from the seat post actuator 113 and/or from another actuator. At block 2204, the actuation command determination circuitry 1904 determines whether the actuation command is a first type of actuation command or a second type of actuation command. If the actuation command is a first type of actuation command, the controller 408 operates in a first mode and implements block 2206-2210. If the actuation command is a second type of command, the controller operates in a second mode and implements blocks 2212-2214. This enables the rider to select different modes of operation for adjusting the height of the seat post 200. As disclosed above, the first and second types of actuation commands can be from the same device, such as the seat post actuator 113. For example, the first type of actuation command may be a long press and hold of the seat post actuator 113, whereas the second type of actuation command may be a shorter press and release of the seat post actuator 113. In other examples, the first type of command can be from the first seat post actuator 113, and the second type of command can be from the second seat post actuator 1908.

If the actuation is the first type of actuation command, the controller 408 operates in the first mode, in which the valve 520 is held open the entire time the seat post actuator 113 is activated. At block 2206, the controller 408 controls the valve actuator 522 to move the valve 520 from the closed state to the open state. When the valve 520 is opened, fluid can flow across the valve 520 between the first and second chambers 516, 518. As such, when the valve 520 is open, the seat post 200 can be expanded (lengthened) or contracted (shortened). At block 2208, the valve is maintained in the open state while the seat post actuator 113 is activated. In some examples, after the valve 520 is opened, the valve actuator 522 is deactivated and the valve 520 remains in the open state. In other examples, the valve actuator 522 continues to be activated to hold the valve 520 in the open state. At block 2210, the controller 408 controls the valve actuator 522 to close the valve 520 when the seat post actuator 113 is deactivated (e.g., released). Therefore, if the actuation command is a first type of actuation command, the controller 408 facilitates momentary user control of the height control mechanism.

If the actuation is the second type of actuation command, the controller 408 operates in the second mode, in which the valve 520 is opened and then automatically closed to result in a small, incremental change in the height of the seat post 200. At block 2212, the controller 408 controls the valve actuator 522 to move the valve 520 from the closed state to the open state. When the valve 520 is opened, fluid can flow across the valve 520 between the first and second chambers 516, 518. At block 2214, the controller 408 automatically, after a predetermined time period, controls the valve actuator 522 to move the valve 520 from the open state to the closed state. In some examples, the predetermined time period is measured from receipt of the control signal corresponding to the second type of actuation command. Therefore, blocks 2212, 2214 may represent the same operations as performed at blocks 2104, 2106 of FIG. 21. In some examples, the predetermined time period is less than 500 ms. In some examples, the automatic closing of the valve 520 is independent of any rider input. As a result of the quick opening and closing, the seat post 200 height is changed by a small, incremental amount.

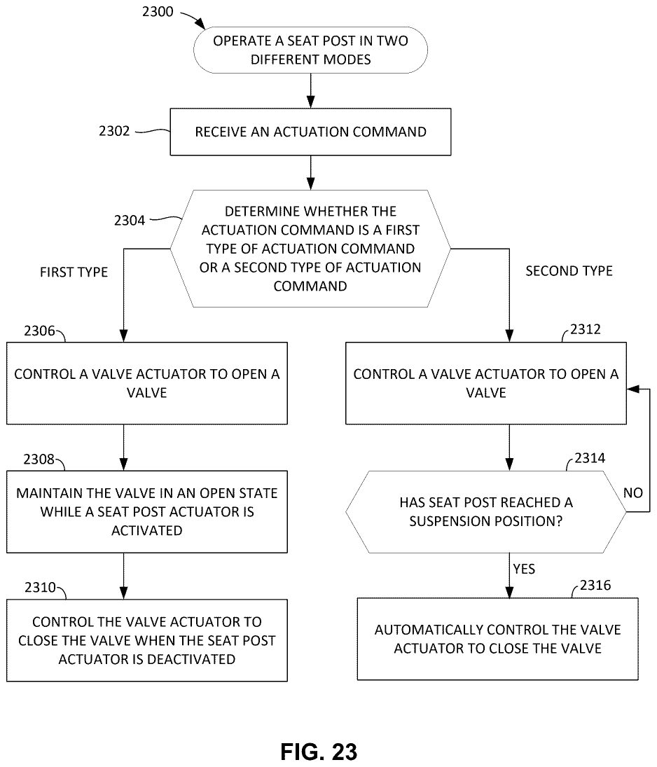

FIG. 23 is a flowchart representative of example machine readable instructions and/or example operations 2300 that may be executed, instantiated, and/or performed by programmable circuitry to operate a seat post in two different modes that enable adjustment of the seat post height. The two different modes correspond to a momentary mode where the user controls the height and the suspension mode where the seat post 200 is moved to and held at the suspension position. The example operations 2300 are described in connection with the height adjustable seat post 200 with the linear valve 520 and the valve actuator 522 (i.e., an electric motor) shown in FIGS. 5-7. However, the example operations 2200 can be similarly performed in connection with the other example valves and actuators disclosed herein.

Blocks 2302-2310 are the same as blocks 2202-2210 described in connection with FIG. 22. A description of these operations is not repeated.

If the actuation is the second type of actuation command, the controller 408 operates in the second (suspension) mode, in which the valve 520 is opened long enough to enable the seat post 200 to move to the suspension position and then closed to maintain the seat post 200 in the suspension position. As disclosed above, the suspension position corresponds to an intermediate height between the maximum and minimum heights of the seat post 200. At block 2312, the controller 408 controls the valve actuator 522 to move the valve 520 from the closed state to the open state. When the valve 520 is opened, the seat post 200 can expand or retract. At block 2314, the controller 408 determines whether the seat post 200 has reached the suspension position. The controller 408 may determine the position of the seat post 200 based on measurements from the seat post position sensor 1920. If the seat post 200 is not at the suspension position, control returns to block 2312 and the valve 520 is maintained in the open position and the controller 408 continues to check/monitor the position of the seat post 200. If the seat post 200 has reached the suspension position, at block 2316, the controller 408 automatically controls the valve actuator 522 to move the valve 520 from the open state to the closed state. Therefore, the seat post 200 is locked or maintained in the suspension position. As disclosed herein, the suspension position enables a larger amount of sag, which helps to absorb shocks and vibrations and therefore acts as a suspension component. The seat post 200 is maintained in the suspension position until the rider provides another actuation command.

FIG. 24 is a block diagram of an example programmable circuitry platform 3100 that can be implemented by the controller 408 and structured to execute and/or instantiate the example machine-readable instructions and/or the example operations of FIGS. 21 and 22.

The programmable circuitry platform 2400 of the illustrated example includes programmable circuitry 2412. The programmable circuitry 2412 of the illustrated example is hardware. For example, the programmable circuitry 2412 can be implemented by one or more integrated circuits, logic circuits, FPGAs, microprocessors, CPUs, GPUs, VPUs, DSPs, and/or microcontrollers from any desired family or manufacturer. The programmable circuitry 2412 may be implemented by one or more semiconductor based (e.g., silicon based) devices. In this example, the programmable circuitry 2412 implements the example power control circuitry 1900, the example valve position determination circuitry 1902, and the example actuation command determination circuitry 1904.

The programmable circuitry 2412 of the illustrated example includes a local memory 2413 (e.g., a cache, registers, etc.). Additionally or alternatively, the programmable circuitry platform 2400 can include main memory 2414, 2416, which includes a volatile memory 2414 and a non-volatile memory 2416. The programmable circuitry 2412 of the illustrated example is in communication with main memory 2414, 2416 by a bus 2418. The volatile memory 2414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2416 may be implemented by flash memory and/or any other desired type of memory device. Access to the main memory 2414, 2416 of the illustrated example is controlled by a memory controller 2417. In some examples, the memory controller 2417 may be implemented by one or more integrated circuits, logic circuits, microcontrollers from any desired family or manufacturer, or any other type of circuitry to manage the flow of data going to and from the main memory 2414, 2416.

The programmable circuitry platform 2400 of the illustrated example also includes interface circuitry 2420. The interface circuitry 2420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2422 are connected to the interface circuitry 2420. The input device(s) 2422 permit(s) a user (e.g., a human user, a machine user, etc.) to enter data and/or commands into the programmable circuitry 2412. The input device(s) 2422 can be implemented by, for example, the seat post actuator 113, the seat post actuator 1908, the position sensor 1906, and/or the seat post position sensor 1910. Additionally or alternatively, the input device(s) 2422 can include a temperature sensor, an audio sensor, a microphone, a camera (still or video), a keyboard, a button, a mouse, a touchscreen, a trackpad, a trackball, an isopoint device, and/or a voice recognition system.

One or more output devices 2424 are also connected to the interface circuitry 2420 of the illustrated example. The output device(s) 2424 can be implemented, for example, the valve actuator 522. Additionally or alternatively, the output device(s) 2424 can include a light, a speaker, a or display device (e.g., a light emitting diode (LED), an organic light emitting diode (OLED), a liquid crystal display (LCD), a cathode ray tube (CRT) display, an in-place switching (IPS) display, a touchscreen, etc.).

The interface circuitry 2420 of the illustrated example can also include a communication device such as the wireless communication device 410. In some examples, the wireless communication device 410 is used to communicate with the input device(s) 2422 and/or output device(s) 2424. In other examples, the input device(s) 2422 and/or output device(s) 2424 can be connected to the interface circuitry 2420 via a physical wired connection.

The programmable circuitry platform 2400 of the illustrated example can also include one or more mass storage discs or devices 2428 to store firmware, software, and/or data. Examples of such mass storage discs or devices 2428 include magnetic storage devices (e.g., drives, HDDs, etc.), and/or solid-state storage discs or devices such as flash memory devices and/or SSDs.

The machine readable instructions 2432, which may be implemented by the machine readable instructions of FIGS. 21-23, may be stored in the mass storage device 2428, in the volatile memory 2414, in the non-volatile memory 2416, and/or on at least one non-transitory computer readable storage medium that may be removable.

While the example piston assemblies, valves, actuators, and controllers disclosed herein are described in connection with seat posts having a pneumatic platform, the examples disclosed herein can also be used in connection with hydraulic platforms. For example, instead of having pneumatic chambers filled with pressurized gas, the chambers 516, 518 can be filled with a hydraulic fluid, such as oil. Therefore, the examples disclosed herein can be used in connection with valves for compressible or incompressible fluids. Also, while the examples disclosed herein utilize a battery in the control module as the power supply to activate the actuator, in other examples, the actuator can be activated from another power supply, such as an electric bicycle battery or from another battery attached to the bicycle.

The example piston assemblies, valves, actuators, and controllers can also be used in other types of bicycle components. For example, any of the example piston assemblies, valves, actuators, and controllers can be used in suspension components (e.g., a shock absorber, a front fork). A suspension component often includes first and second tubes arranged in a telescopic arrangement. The example piston assemblies, valves, and actuators disclosed herein can be used as a damper or a spring component to control the flow of fluid between two chambers in the tube(s). The example controller techniques disclosed herein can be used to make incremental changes in the height or length of a suspension component.

Example systems, apparatus, and articles of manufacture for bicycles (and/or other vehicles) are disclosed herein. Examples and combinations of examples disclosed herein include the following clauses.

A height adjustable . . . ADD CLAUSES

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Descriptors “first,” “second,” “third,” etc. are used herein when identifying multiple elements or components that may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A height adjustable seat post for a bicycle, the height adjustable seat post comprising:
a first tube and a second tube configured in a telescopic arrangement, one of the first tube or the second tube to be coupled to a frame of the bicycle, the other of the first tube or the second tube to be coupled to a seat;
a first chamber;
a second chamber;
a valve disposed fluidly between the first chamber and the second chamber, the valve including a flow control member that is moveable between a closed position in which fluid is blocked from flowing across the valve between the first and second chambers and an open position to enable the flow of fluid across the valve between the first and second chambers;
a valve actuator to move the flow control member of the valve between the closed position and the open position; and
a controller to:
receive a control signal;
in response to receiving the control signal, control the valve actuator to move the flow control member from the closed position to the open position; and
automatically, after a predetermined time period, control the valve actuator to move the flow control member from the open position to the closed position.

2. The height adjustable seat post of claim 1, wherein a first time period is defined between receiving the control signal and the flow control member achieving the open position, and a second time period is defined between the flow control member achieving the open position and the valve actuator moving the flow control member from the open position to the closed position, wherein the predetermined time period includes the first time period and wherein the first time period is at least five percent (5%) of the predetermined time period.

3. The height adjustable seat post of claim 1, wherein the predetermined time period begins from receiving the control signal and is less than five hundred milliseconds (500 ms).

4. The height adjustable seat post of claim 1, wherein the predetermined time period is between twenty milliseconds (20 ms) and one hundred milliseconds (100 ms).

5. The height adjustable seat post of claim 1, wherein the predetermined time period is adjustable based on at least one environmental or user setting.

6. The height adjustable seat post of claim 1, wherein the valve actuator is an electric motor.

7. The height adjustable seat post of claim 6, wherein the controller is to activate the electric motor in one direction to move the flow control member from the closed position to the open position and in an opposite direction to move the flow control member from the open position to the closed position.

8. The height adjustable seat post of claim 1, wherein the valve actuator is a solenoid.

9. The height adjustable seat post of claim 8, wherein the controller is to activate the solenoid to move the flow control member from the closed position to the open position, and wherein the controller is deactivate the solenoid to move the flow control member from the open position to the closed position.

10. The height adjustable seat post of claim 1, wherein the valve is a linear valve, and wherein the flow control member is a plug that is moveable in a linear direction between the closed position and the open position.

11. The height adjustable seat post of claim 1, wherein the valve is a rotary valve, and wherein the flow control member is a first disc that is rotatable relative to a second disc between the open position and the closed position.

12. A height adjustable seat post for a bicycle, the height adjustable seat post comprising:
a first tube and a second tube configured in a telescopic arrangement, one of the first tube or the second tube to be coupled to a frame of the bicycle, the other of the first tube or the second tube to be coupled to a seat;
a height control mechanism to selectively facilitate relative movement between the first tube and the second tube in an open state and to restrict relative movement between the first tube and the second tube in a closed state; and
a controller to determine whether an actuation command is a first type of actuation command or a second type of actuation command,
wherein, when the actuation command is a first type of actuation command, the controller is to control the height control mechanism to the open state when a seat post actuator is activated, maintain the open state while the seat post actuator is activated, and control the height control mechanism to the closed state when the seat post actuator is deactivated, and
wherein, when the actuation command is the second type of actuation command, the controller is to control the height control mechanism to the open state and then automatically, after a predetermined time period, control the height control mechanism to the closed state.

13. The height adjustable seat post of claim 12, wherein the predetermined time period is less than 500 milliseconds (500 ms).

14. The height adjustable seat post of claim 12, wherein the first type of actuation command corresponds to a continuous activation of the seat post actuator for a first amount of time, and wherein the second type of actuation command corresponds to a continuous activation of the seat post actuator for a second amount of time that is shorter than the first amount of time.

15. The height adjustable seat post of claim 12, wherein the second type of actuation command corresponds to a second seat post actuator.

16. The height adjustable seat post of claim 12, wherein the height control mechanism includes a valve in the first tube, the valve dividing the first tube into a first chamber and a second chamber, the valve operable between the open state and the closed state by a valve actuator.

17. The height adjustable seat post of claim 16, wherein a first time period is defined between determining the second type of actuation command and the height control mechanism achieving the open position, a second time period is defined between the height control mechanism achieving the open position and automatically controlling the height control mechanism to the closed state, wherein the first time period is at least five percent (5%) of the predetermined time period.

18. A height adjustable seat post for a bicycle, the height adjustable seat post comprising:
a first tube and a second tube configured in a telescopic arrangement, one of the first tube or the second tube to be coupled to a frame of the bicycle, the other of the first tube or the second tube to be coupled to a seat;
a height control mechanism to selectively facilitate relative movement between the first tube and the second tube in an open state and to restrict relative movement between the first tube and the second tube and a closed state; and
a controller to determine whether an actuation command is a first type of actuation command or a second type of actuation command,
wherein, when the actuation command is a first type of actuation command, the controller is to facilitate momentary user control of the height control mechanism, and
wherein, when the actuation command is the second type of actuation command, the controller is to facilitate automatic achievement of a suspension mode with the height control mechanism.

19. The height adjustable seat post of claim 18, wherein the first tube and the second tube are moveable relative to one another to define:
an extended position representing a maximum length of the telescopic arrangement;
a retracted position representing a minimum length of the telescopic arrangement; and
a suspension position corresponding to the suspension mode and representing an intermediate length greater than the minimum length and less than the maximum length.

20. The height adjustable seat post of claim 19, wherein a suspension sag value defined at the suspension position is greater than an extended sag value defined at the extended position.
